(19) United States
(12) Patent Application Publication
(10) Pub. No.: US 2025/0059690 A1
(43) Pub. Date: Feb. 20, 2025

(54) APPARATUS AND METHOD TO PROVIDE A PATHOGENICIDAL BARRIER BETWEEN FIRST AND SECOND REGIONS

(71) Applicant: X CELL, LLC, Tampa, FL (US)

(72) Inventors: Sunil J. PANCHAL, Tampa, FL (US); Pedro SOLER, Tampa, FL (US); Arlo HENDERSON, Tampa, FL (US); Peter BUCKEN, Tampa, FL (US)

(21) Appl. No.: 18/720,914

(22) PCT Filed: Dec. 19, 2022
(86) PCT No.: PCT/US22/53364

§ 371 Date: Jun. 17, 2024

Related U.S. Application Data
(60) Provisional application No. 63/290,751, filed on Dec. 17, 2021.

(51) Int. Cl. D04H 3/16; A41D 13/11; B01D 39/16; B65D 81/24; D01D 5/098; D01F 11/04; D04H 1/413

(52) U.S. Cl. CPC D04H 3/16; A41D 13/1192; B01D 39/1623; B65D 81/24; D01D 5/0985; D01F 11/04; D04H 1/413; B01D 2239/0442; B01D 2239/0618; B01D 2239/0622; B01D 2239/10; D10B 2401/13; D10B 2505/04; D10B 2505/10; D10B 2509/00

(57) ABSTRACT

A method is provided to form a barrier configured to be placed between a first region and a second region, to prevent passage of pathogens between the first region and the second region. The method includes melt blowing a stream of polymer fibers onto a surface to form a non-woven fabric used to make the barrier. The melt blowing includes introducing pathogenicidal components into the stream of polymer fibers. A device of a system is also provided to form the barrier according to the method disclosed herein. The device is configured to introduce pathogenicidal components into the stream of polymer fibers downstream of the extruder and upstream of the collector.

### BACKGROUND

It is commonly known that pathogens such as viruses and bacteria are easily transmitted between people via direct and indirect contact. An example of direct transmission is when aerosolization of pathogens occur during exhalation, coughing, or sneezing, and is transferred to another individual. Indirect transmission occurs when pathogens contact and reside on an intervening surface such as doorknobs, countertops, tabletops, or on an individual's hand.

### SUMMARY

Techniques are provided for providing a barrier treated with pathogenicidal components positioned between a first region and a second region to kill or deactivate pathogens (e.g. virus particles) and thus prevent transmission of pathogens between the first and second regions.

The inventors recognized that various conventional methods are available (e.g. melt blowing) which can be used to form non-woven fabric from a polymer material, that can then be used as a barrier between a first region and a second region. However, the inventors recognized that such conventional methods do not add pathogenicidal components (e.g. salt crystals) to the non-woven fabric, which would enhance the prevention of transmission of pathogens between the first and second region. The inventors then considered that the melt blowing method could be used to form non-woven fabric, after which pathogenicidal components (e.g. salt crystals) could be added to the non-woven fabric using various means (e.g. soaking the non-woven fabric in a salt solution for 24-36 hours). However, the inventors recognized that such a method would be time consuming, as it would require about 24-36 hours (e.g. due to curing) to form the barrier with the pathogenicidal components. Thus, the inventors developed the improved method disclosed herein, where pathogenicidal components are incorporated into the melt blowing process, such that the non-woven fabric formed by the melt blowing process already has pathogenicidal components embedded therein. This eliminates the time consuming step of adding pathogenicidal components to the non-woven fabric after the melt blowing process (e.g. during a curing step that may extend for 24-36 hours). Consequently, as a result of the improved melt blowing process, the non-woven fabric with embedded pathogenicidal components can be formed in under one hour, as opposed to 24-36 hour with the conventional melt blowing process.

The inventors recognized that conventional masks are available which attempt to prevent the transmission of pathogens between two regions. In one example, conventional masks are available which provide an interior layer treated with pathogenicidal components (e.g. virucidal components) sandwiched between two exterior layers that are not treated with pathogenicidal components. Although the interior layer of these conventional masks is used to kill or deactivate pathogens, the untreated exterior layers of these masks become contaminated when pathogens contact these exterior layers. Consequently, when the user touches or removes the mask, they contaminate their hand and thus may subsequently contaminate themselves (e.g. touching their face) or other surfaces (e.g. by touching these surfaces). Additionally, the inventors of the present invention recognized that disposing this contaminated mask may cause further contamination of other surfaces that make contact with the exterior layer during disposal. To overcome this drawback of conventional masks, the inventors of the present invention developed the improved method disclosed herein, to form a barrier (e.g. single ply barrier or multiple layer barrier) that is treated with pathogenicidal components that can be worn over the face as a facial cover. This improved method is used to form the barrier that advantageously kills or deactivates incident pathogens and thus minimizes the risk of contamination of the barrier. Thus, the improved barrier formed by the method disclosed herein minimizes the risk of contamination of the user (e.g. when touching or disposing of the barrier) and other surfaces (e.g. when the barrier is discarded).

The inventors recognized other drawbacks of conventional masks. For example, since the conventional masks include multiple layers, the air permeability and thus the breathability of these masks is severely limited. This can pose health concerns for individuals who suffer from respiratory illnesses (e.g. asthma). Additionally, this can severely restrict the breathing of athletes who may be required to wear such conventional masks during sports activity (e.g. due to laws and/or regulations governing viral pandemics). To overcome this significant drawback of conventional masks, the inventors of the present invention developed the improved method disclosed herein, to form the barrier (e.g., single ply barrier or multiple layer barrier) that is treated with pathogenicidal components that can be worn over the face. In some embodiments, the improved barrier formed by the improved method disclosed herein only includes a single ply layer, and thus has significantly higher air permeability and breathability than conventional masks, while at the same time being at least as effective in killing or deactivating pathogens. However, the invention is not limited to barriers formed of a single-ply layer and in other embodiments includes barriers formed from multiple layers.

The inventors also recognized another drawback of conventional masks. For example, during viral pandemics there is a well-known shortage of certain masks (e.g. N95) used by medical professionals. This shortage is facilitated by the frequency by which these masks are discarded after a certain amount of use. Although there are certain methods that can be used to sterilize such masks after multiple uses, these sterilization methods can damage the mask material and thus affect the performance of these masks during reuse. To overcome this noted drawback of shortage of certain masks, the inventors of the present invention developed the improved method disclosed herein, to form a barrier that is treated with pathogenicidal components that can be used to enclose a conventional mask (e.g. N95) to minimize contamination of the mask. This advantageously extends the lifetime of the conventional mask and thus reduces the instance of shortage of the conventional masks. Additionally, the barrier formed by the improved method disclosed herein also improves upon other methods (e.g. sterilization) that may affect the performance of the conventional masks during reuse.

The inventors of the present invention noticed that attempts to reduce transmission include prior inventions of masks. However, the limitations of masks are that the external surface (facing away from the user, and the internal surface (facing the user) are inherently contaminated whether from the environment or from the user and thus present a risk for infection if an individual does not remove and dispose of the mask correctly. This represents a risk to the user, as well as others via indirect transmission. Also, in the situation of a pandemic, with the result of shortages of personal protective equipment, many individuals are forced to reuse protective masks, and often do not have a reliable means of sterilizing a mask for reuse. Furthermore, some methods of sterilization result in a breakdown of the fibers of the mask, thereby reducing its effectiveness in filtering out pathogens. When shortages occur, many individuals are forced to use simple cloth face covers, which are not reliable for preventing airborne transmission, and still pose a risk to enable indirect transmission when removed.

In one embodiment, the present invention provides an improved method to form a cover for a mask, which has embedded pathogenicidal components (e.g. virucidal and/or bactericidal components), providing protection for both the external and internal surfaces of a mask, preventing/reducing contamination of a mask, thereby improving safety if reuse is necessary, and by inactivating or destroying pathogens, reducing risk of indirect transmission when the cover is removed and disposed. If a mask was not available for use, the individual may also elect to use this invention to form a face cover and provide a measure a safety due to the embedded pathogenicidal and bactericidal components.

The inventors of the present invention also recognized other contexts than facial covers where barriers to prevent pathogens passing from the first region to the second region are either deficient or not provided. For example, air filters (e.g. for air-conditioning systems or ventilators, etc.), apparel (e.g. garments for medical professionals or any clothing items worn by everyday people) and food storage (e.g. to prevent pathogens in the air from contaminating and/or spoiling food). The inventors recognized that with conventional food packaging (e.g. shipping containers or storage containers) there is no effective barrier to prevent pathogens from making contact with the food, thereby resulting in contamination and/or spoilage of the food. Thus, in some embodiments the inventors of the present invention developed a barrier with pathogenicidal components that is effective to prevent contamination and/or spoilage of food by preventing pathogens from making contact with the food items enclosed by the barrier.

In a first set of embodiments, a method is provided to form a barrier configured to be placed between a first region and a second region, to prevent passage of pathogens between the first region and the second region. The method includes melt blowing a stream of polymer fibers onto a surface to form a non-woven fabric used to make the barrier. The melt blowing includes introducing pathogenicidal components into the stream of polymer fibers.

In a second set of embodiments, a device of a system is provided to form a barrier configured to be placed between a first region and a second region, to prevent passage of pathogens between the first region and the second region. The system includes an extruder configured to melt polymer pellets to form pressurized molten polymer. The system further comprising a metering pump configured to discharge a consistent flow of pressurized molten polymer received from the extruder. The system further includes a spinneret configured to extrude polymer filament strands from holes defined by the spinneret based on the pressurized molten polymer received from the metering pump. The system further includes an air manifold configured to attenuate the polymer filament strands into the stream of polymer fibers that are directed onto a collector that defines the surface to form the non-woven fabric. The device is configured to introduce pathogenicidal components into the stream of polymer fibers downstream of the extruder and upstream of the collector.

In a third set of embodiments, a barrier formed by the method according to the first set of embodiments is provided. The barrier includes a first side directed towards the first region and a second side directed towards the second region.

In a fourth set of embodiments, a facial cover configured to be worn by a user is provided. The facial cover includes one or more barriers formed by the method according to the first set of embodiments. The one or more barriers are configured to deactivate pathogens incident from the external surroundings of the user.

Still other aspects, features, and advantages are readily apparent from the following detailed description, simply by illustrating a number of particular embodiments and implementations, including the best mode contemplated for carrying out the invention. Other embodiments are also capable of other and different features and advantages, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

Embodiments are illustrated by way of example, and not by way of limitation, in the figures of the accompanying drawings in which like reference numerals refer to similar elements and in which:

FIG. 1A is a schematic diagram that illustrates an example of a single ply barrier layer with pathogenicidal components between a first and second region, according to an embodiment;

FIG. 1B is a schematic diagram that illustrates an example of a multiple layer barrier with pathogenicidal components between a first and second region, according to an embodiment;

FIG. 2A is an image that illustrates an example of a perspective view of the barrier of FIG. 1A or 1B worn as a facial cover, according to an embodiment;

FIG. 2B is an image that illustrates an example of a perspective view of the barrier of FIG. 1A or 1B worn as a facial cover, according to an embodiment;

FIG. 2C is an image that illustrates an example of a cross-sectional view of the barrier of FIG. 2A taken along the line 2C-2C;

FIG. 2D is an image that illustrates an example of a front view of an oval shaped facial cover of FIG. 2A, according to an embodiment;

FIG. 2E is an image that illustrates an example of a front view of a facial cover of FIG. 2A with an attached elastic fastener, according to an embodiment;

FIG. 2F is an image that illustrates an example of a front view of the facial cover of FIG. 2A taking an arcuate shape, according to an embodiment;

FIG. 2G is an image that illustrates an example of a front view of an elastic fastener to be used to secure the facial cover of FIG. 2F to the face, according to an embodiment;

FIG. 2H is an image that illustrates an example of a rear view of the facial cover of FIG. 2F with elastic to affix the facial cover to the face, according to an embodiment;

FIG. 3A is an image that illustrates an example of a perspective view of a facial cover including the barrier of FIG. 1A or 1B covering a mask, according to an embodiment;

FIG. 3B is an image that illustrates an example of a cross-sectional view of the facial cover of FIG. 3A taken along the line 3B-3B;

FIG. 3C is an image that illustrates an example of a perspective view of a facial cover including the barrier of FIG. 1A or 1B enclosing a mask, according to an embodiment;

FIG. 3D is an image that illustrates an example of a cross-sectional view of the facial cover of FIG. 3C taken along the line 3D-3D;

FIG. 3E is an image that illustrates an example of a front view of the barrier of FIG. 3C before enclosing the mask, according to an embodiment;

FIG. 3F is an image that illustrates an example of a rear view of the barrier of FIG. 3A before enclosing the mask, according to an embodiment;

FIG. 4A is an image that illustrates an example of a schematic diagram of the barrier of FIG. 1A or 1B used as an air filter in an air conditioning system, according to an embodiment;

FIG. 4B is an image that illustrates an example of a schematic diagram of the air filter of the air conditioning system of FIG. 4A, according to an embodiment;

FIG. 5 is an image that illustrates an example of a schematic diagram of the barrier of FIG. 1A or 1B used to form a garment worn by a medical professional, according to an embodiment;

FIG. 6 is an image that illustrates an example of a schematic diagram of the barrier of FIG. 1A or 1B used as a filter in a ventilator, according to an embodiment;

FIG. 7 is a flow chart that illustrates an example of a method for forming the barrier of FIG. 1A or 1B, according to an embodiment;

FIG. 8A is an image that illustrates an example of a graph that depicts an intensity of X-ray Diffraction (XRD) of the barrier of FIG. 1A or 1B, according to an embodiment;

FIG. 8B is an image that illustrates an example of different miller indices used for the XRD depicted in the graph of FIG. 8A;

FIG. 9A is an image that illustrates an example of light scattering of particles downstream of a conventional mask, according to an embodiment;

FIG. 9B is an image that illustrates an example of light scattering of particles downstream of a conventional surgical mask, according to an embodiment;

FIG. 9C is an image that illustrates an example of light scattering of particles downstream of the barrier of the facial cover of FIG. 2A, according to an embodiment;

FIG. 10 is an image that illustrates an example of a graph that depicts viral filtration efficiency (VFE) of the barrier of FIG. 1A or 1B, according to an embodiment;

FIG. 11 is a block diagram that illustrates an example of a system to form non-woven fabric of the barrier of FIG. 1A or 1B, according to an embodiment;

FIGS. 12A through 12E are schematic diagrams that illustrates an example of a system to form the barrier of FIG. 1A or 1B, according to an embodiment;

FIGS. 12F through 12J are schematic diagrams that illustrates an example of a hopper of the system of FIG. 12A or 12E, according to an embodiment;

FIG. 13 is an image that illustrates an example of non-woven fabric with embedded pathogenicidal components formed by the system of FIG. 11, according to an embodiment;

FIG. 14 is a flow chart that illustrates an example of a method for using the system of FIG. 11 to form the barrier of FIG. 1A or 1B, according to an embodiment; and

FIGS. 15A and 15B are images that illustrate an example of a schematic diagram of the barrier of FIG. 1A or 1B used to package food items, according to an embodiment.

### DETAILED DESCRIPTION

A method and apparatus are described for providing a barrier (e.g. single ply layer barrier, multiple layer barrier, etc.) treated with pathogenicidal components between a first and second region to prevent passage of pathogens between the first and second regions. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Some embodiments of the invention are described below in the context of a method for forming a barrier positioned between a first region and a second region to prevent passage or transmission of pathogens between the first and second regions. In one embodiment, the invention is described in the context of a melt blowing method for forming a barrier positioned between the first region and the second region. However, the invention is not limited to this context and includes a barrier formed by the method including a single ply layer or a multiple layer barrier with pathogenicidal components that is positioned between the first and second regions to prevent passage or transmission of viral particles between the first and second regions.

For purposes of this description, “barrier” means one or more layer(s) of material treated with pathogenicidal (e.g. virucidal or bactericidal components) and positioned between a first and second region to prevent or reduce the instance of transmission of pathogens between the first and second regions. In one example, “barrier” means a single ply layer of the material treated with pathogenicidal components. In other examples, “barrier” means multiple layers of the material (e.g. multiple single-ply layers that are affixed together) treated with pathogenicidal components. In still other examples, “barrier” means multiple layers where one or more layers are treated with pathogenicidal components and one or more other layers are not treated with the pathogenicidal components. For purposes of this description, “single ply layer” means a single layer of material and excludes multiple layers of the material or additional layers of a different material. For purposes of this description, “pathogenicidal components” means any chemical or molecule having the capacity to or tending to destroy or inactivate pathogens and includes (but is not limited to) virucidal components and bactericidal components. For purposes of this description, “virucidal components” means any chemical or molecule having the capacity to or tending to destroy or inactivate viruses. For purposes of this description, “bactericidal components” means any chemical or molecule having the capacity to or tending to destroy or inactivate bacteria. For purposes of this description, “mask” means a conventional facial mask worn to reduce the instance of transmission of pathogens (e.g. N95 mask) and including multiple layers of material. For purposes of this description, “facial cover” means a cover worn over the face that includes the barrier disclosed herein.

In one embodiment, the present invention provides a cover for a mask, or cover for the face, suitable for wear, which inhibits the passage of viruses and bacteria, and is treated with a compound designed to destroy viruses and bacteria. This cover will allow the user to reuse the mask, whether it be a surgical mask, N95 mask, KN95 mask, P100 mask, or other masks that an individual may use, by reducing contamination of the mask. This invention will also reduce contamination of the user's environment upon disposal, due to the treatment with a compound designed to kill viruses and bacteria.

### 1. Barrier Structure and Features

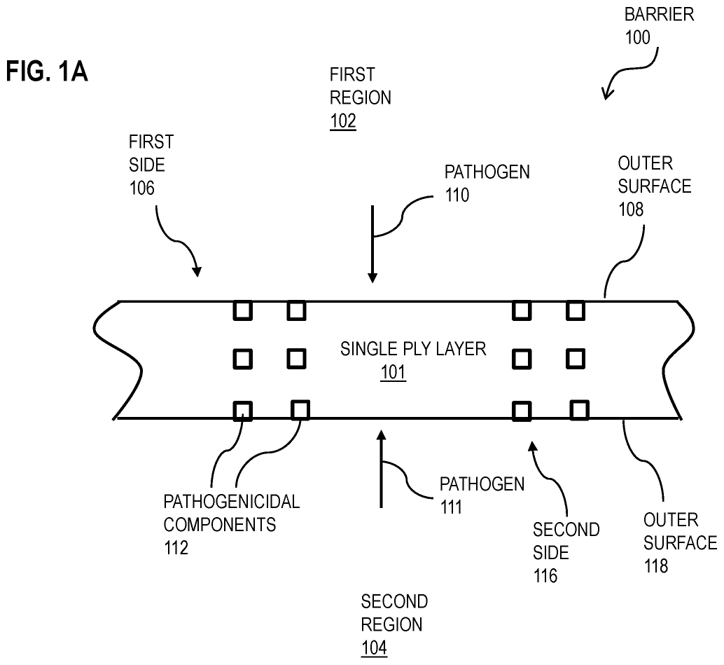

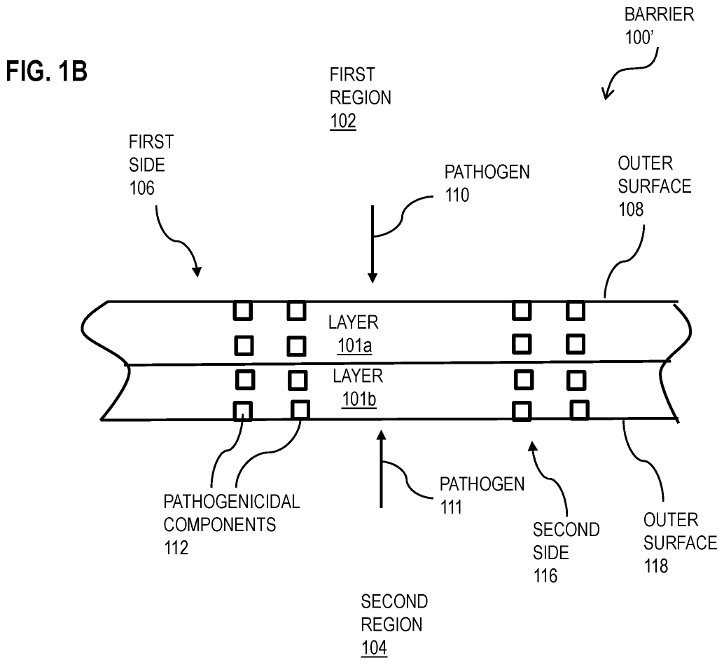

FIG. 1A is a schematic diagram that illustrates an example of a barrier 100 positioned between a first region 102 and a second region 104. In an embodiment, a pathogen 110 (e.g. viral particle in an aerosol droplet) is incident from the first region 102 onto the barrier 100. In another embodiment, a pathogen 111 (e.g. viral particle in an aerosol droplet) is incident from the second region 104 onto the barrier 100. Although FIG. 1 depicts pathogens 110, 111 incident on the single ply layer 101 from both regions 102, 104, in some embodiments only one of the pathogens 110 or 111 from one of the regions 102 or 104 are incident on the single ply layer 101.

Although FIG. 1A depicts that the barrier 100 is a single-ply layer 101, in other embodiments, the barrier can include multiple layers (e.g. multiple single-ply layers 101 affixed together). FIG. 1B is a schematic diagram that illustrates an example of a multiple layer barrier 100′ with pathogenicidal components 112 between a first and second region 102, 104, according to an embodiment. In one embodiment, the barrier 100′ includes multiple layers 101a, 101b where each layer 101a, 101b is similar to the layer 101 of FIG. 1A. In one embodiment the multiple layers 101a, 101b are affixed together using any known means appreciated by one of skill in the art. Although FIG. 1B depicts an example embodiment of the barrier 100′ with two layers 101a, 101b in other embodiments, the barrier 100′ includes more than two layers. Additionally, although FIG. 1B depicts an example embodiment, where each layer 101a, 101b includes pathogenicidal components 112, in other embodiments the barrier 100′ includes one or more layers that do not include pathogenicidal components 112 (e.g. an interior layer between two outer layers 101a, 101b that include pathogenicidal components 112).

In an embodiment, the barrier 100 includes a single ply layer 101 positioned between the first region 102 and the second region 104 and the barrier 100′ includes multiple layers 101a, 101b positioned between the first and second regions 102, 104. As shown in FIGS. 1A and 1B, in one embodiment the barrier 100, 100′ extends along an interface between the first and second regions 102, 104 by a sufficient distance to prevent passage of the pathogens 110, 111 between the first and second regions 102, 104. This distance that the barrier 100, 100′ extends along the interface of the first and second regions 102, 104 depends on the specific arrangement and context of the first and second regions 102, 104. In some embodiments, the single ply layer 101 only includes a single layer of material and excludes additional layers positioned between the first region 102 and the second region 104. In other embodiments, the barrier 100′ includes multiple layers 101a, 101b (e.g. multiple single-ply layers 101 affixed together) positioned between the first region 102 and the second region 104. In an example embodiment, the barrier 100, 100′ comprises woven or nonwoven layers of material, including one or more of microfibril cloth, tightly woven cotton cloth, absorbent cellulose fiber layers, woven fabrics, textiles, polymer-laid fabrics (e.g., spunbonded and meltblown), dry-laid and wet-laid non-wovens, etc. In an example embodiment, polypropylene is the preferred material for the barrier 100, 100′. In an example embodiment, the barrier 100, 100′ includes pores in each layer 101 with a dimension in a certain range (e.g. about 4 microns and/or in a range from about 3 microns to about 5 microns and/or in a range from about 2 microns to about 6 microns).

In an embodiment, the barrier 100, 100′ includes pathogenicidal components 112 within each layer 101. In one embodiment, each layer 101 of the barrier 100, 100′ is treated with pathogenicidal components 112 using a method discussed hereinafter. In yet another embodiment, the pathogenicidal components are integrated or incorporated into the layer 101 of the barrier 100, 100′, during the manufacturing process of the barrier 100, 100′. In one embodiment, the layer 101 of the barrier 100, 100′ is treated with single or combinations of components that possess virucidal and/or bactericidal properties. In an example embodiment, these components include one or more of acids, salts, or esters. In one example embodiment, the components include citric acid, any carboxylic acid, or any mineral acid. In another example embodiment, the components include one or more of citrate esters, vitamin C esters, pyruvate, citrate, isocitrate, ketoglutarate, succinate, fumarate, malate, oxaloacetate or basic components (e.g., such as soaps, sodium lauryl sulfate, quaternary ammonium salts; cationic, anionic and nonionic surfactants, or tallow amines). In an example embodiment, the concentration of the acidic components may range from about 11% to about 100% of the acid, salt, or ester, and the concentration of the basic components may range from about 0.1% to about 10% of the surfactant, salt or ester. In yet another example embodiment, other pathogenicidal components (e.g., virucidal and/or bactericidal components) that may be utilized include NaCl, zinc disodium EDTA, copper, nickel, iodine, manganese, tin, boron, or silver; salts thereof; chelants thereof; chelactants thereof; surfactant-linked compositions thereof; or ions thereof. In an example embodiment, the metal virucidal composition may range from about 1% to about 100% solution, and also colloids and phycocolloids may be utilized.

In another embodiment, the barrier 100, 100′ is treated with the pathogenicidal components 112 across an entire thickness of the barrier 100, 100′ (e.g., entire thickness of the single ply layer 101 in the barrier 100 or an entire thickness of each layer 101a, 101b of the multiple-layer barrier 100′). Thickness is a dimension perpendicular to the interface between the regions 102, 104 and extending from the first region 102 to the second region 104. As shown in FIGS. 1A and 1B, in one example embodiment, the barrier 100, 100′ is treated with the pathogenicidal components 112 along an entire thickness of the barrier 100, 100′ from an outer surface 108 of a first side 106 of the barrier 100, 100′ to an outer surface 118 of a second side 116 of the barrier 100, 100′. Where the barrier 100′ is a multiple-layer barrier, the barrier 100′ is treated with pathogenicidal components 112 along an entire thickness of the multiple layers of the barrier 100′ from an outer surface 108 of a top layer 101a of the multiple layer barrier to an outer surface 118 of a bottom layer 101b of the multiple layer barrier 100′. In an example embodiment, the pathogenicidal components 112 include one or more of salt, acid and esters. FIGS. 1A and 1B are not drawn to scale and thus although portions of the layer(s) 101, 101a, 101b do not include the pathogenicidal components 112, this is merely for ease of illustration and in one embodiment the pathogenicidal components 112 are provided along the length (e.g. uniformly arranged along the entire length) of each layer 101, 101a, 101b over the interface between the regions 102, 104.

In an example embodiment, salt is effective as a virucidal component to kill and/or deactivate a viral particle, since the viral particle is usually incident on the barrier 100, 100′ in a water droplet (e.g. aerosol). Once the water droplet containing the viral particle makes contact with the layer(s) 101 of the barrier 100, 100′, salt crystals within the layer(s) 101 dissolve in the water droplet. Over time, the water droplet evaporates, thus reducing the water volume containing the viral particle and consequently increasing the relative salt concentration. Once the salt concentration reaches a sufficient level, the salt deactivates and/or kills the viral particle.

In an embodiment, the first side 106 of the barrier 100, 100′ is directed toward the first region 102. In an example embodiment, the outer surface 108 of the first side 106 is coated with the pathogenicidal components 112 and is directed toward the first region 102 such that the pathogen 110 in the first region 102 is incident on the outer surface 108 of the first side 106. In another example embodiment, the outer surface 108 of the first side 106 is the first surface that is encountered by the pathogen 110 incident on the barrier 100, 100′ (e.g. no other layer or surface or component of the barrier 100 interacts with the pathogen 110 before the outer surface 108).

In an embodiment, the second side 116 of the barrier 100, 100′ is directed toward the second region 104. In an example embodiment, the outer surface 118 of the second side 108 is coated with the pathogenicidal components 112 and is directed toward the second region 102 such that the pathogen 111 in the second region 104 is incident on the outer surface 118 of the second side 116. In another example embodiment, the outer surface 118 of the second side 116 is the first surface that is encountered by the pathogen 111 incident on the second side 116 (e.g. no other layer or surface or component of the barrier 100 makes contact with the pathogen 111 before the outer surface 118). In an example embodiment, the pathogenicidal components 112 coated on the outer surfaces 108, 118 of the first side 106 and the second side 116 are configured to deactivate the pathogens 110, 111 (e.g. viral particles in aerosol) incident on the outer surfaces 108, 118 of the respective first side 106 and the second side 116.

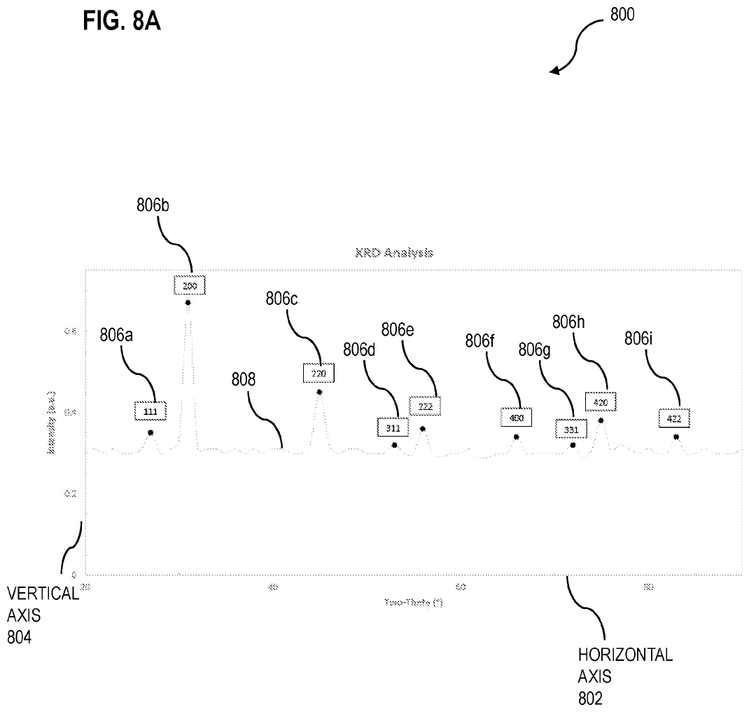

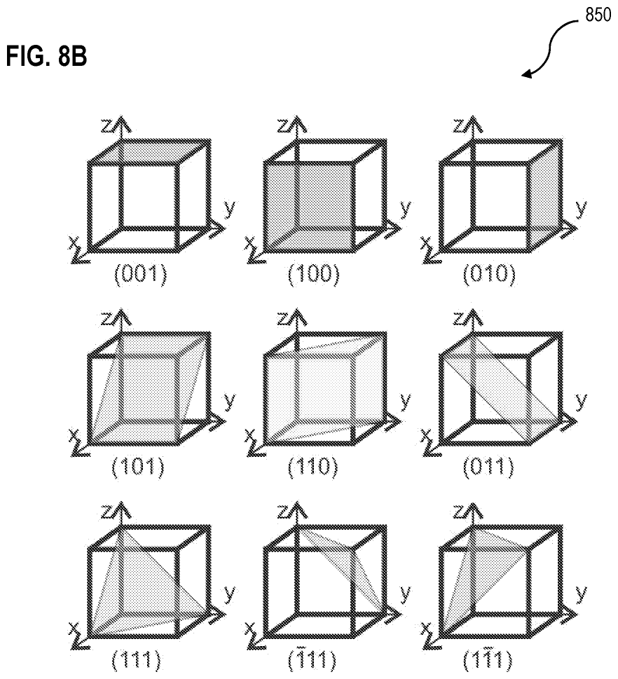

In an embodiment, the pathogenicidal components 112 comprise salt with a level of crystallization of across a thickness of the layer(s) 101 of the barrier 100, 100′ from the outer surface 108 of the first side 106 to the outer surface 118 of the second side 116. In an embodiment the level of crystallization of the salt is measured based on X-ray Diffraction (XRD) Analysis as discussed hereafter with respect to FIGS. 8A and 8B.

In an embodiment, the barrier 100, 100′ has an air permeability that is greater than a threshold value of air permeability. In one embodiment, the air permeability is based on a value of an air pressure difference across the barrier 100, 100′ (e.g. between the first side 106 and the second side 116) based on an airflow passed through the barrier 100, 100′ at a constant flowrate (e.g. about 8 L/min or in a range from about 4 L/min to about 12 L/min). In an example embodiment, the air permeability of the barrier 100, 100′ is such that the air pressure difference is less than about 0.2 mm H₂0/cm². In another example embodiment, the air permeability is such that the air pressure difference is less than about 0.1 mm H₂0/cm².

In an embodiment, the barrier 100, 100′ has a viral filtration efficiency between the first and second regions 102, 104 that is above a threshold filtration efficiency (e.g. 85%). In one embodiment, the viral filtration efficiency of the barrier 100, 100′ is at least 95% between the first region 102 and the second region 104.

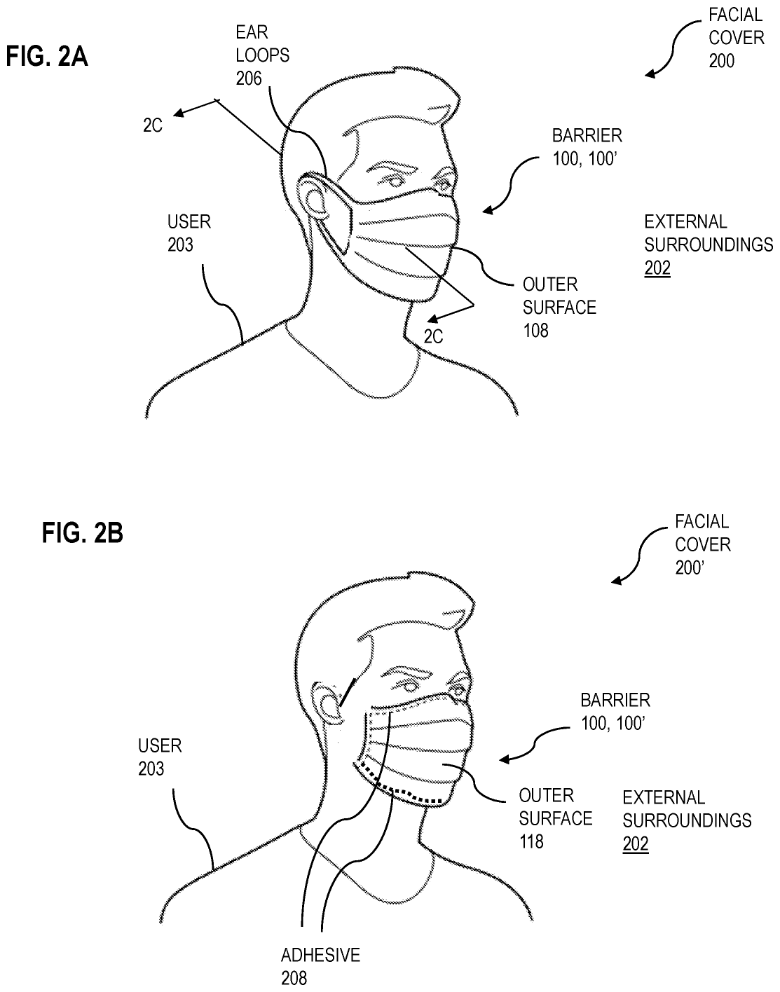

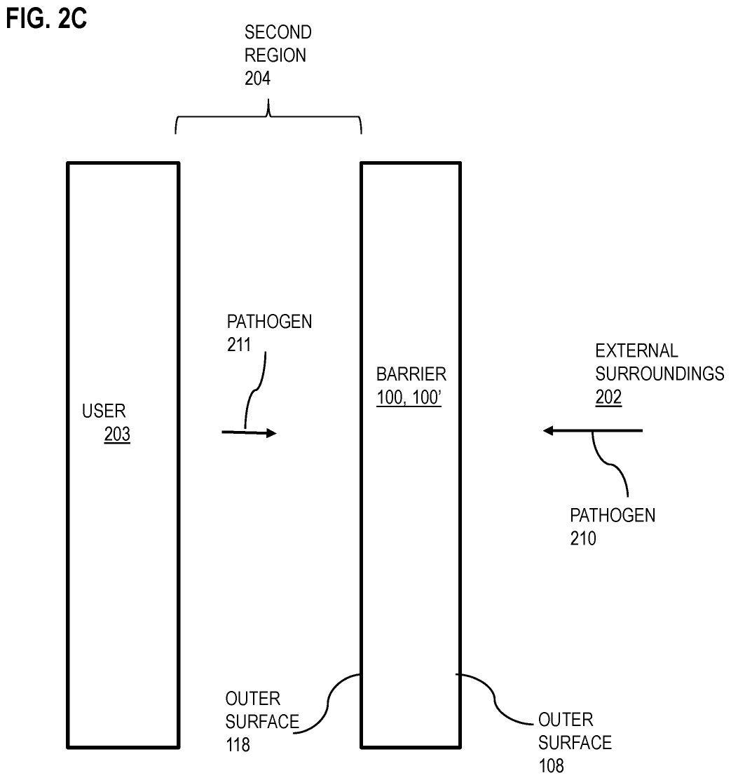

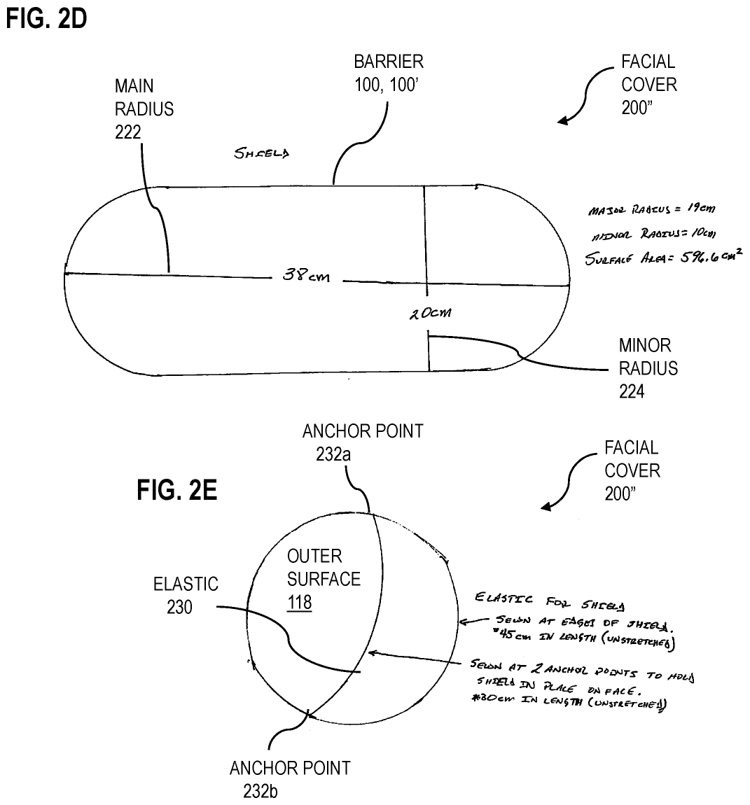

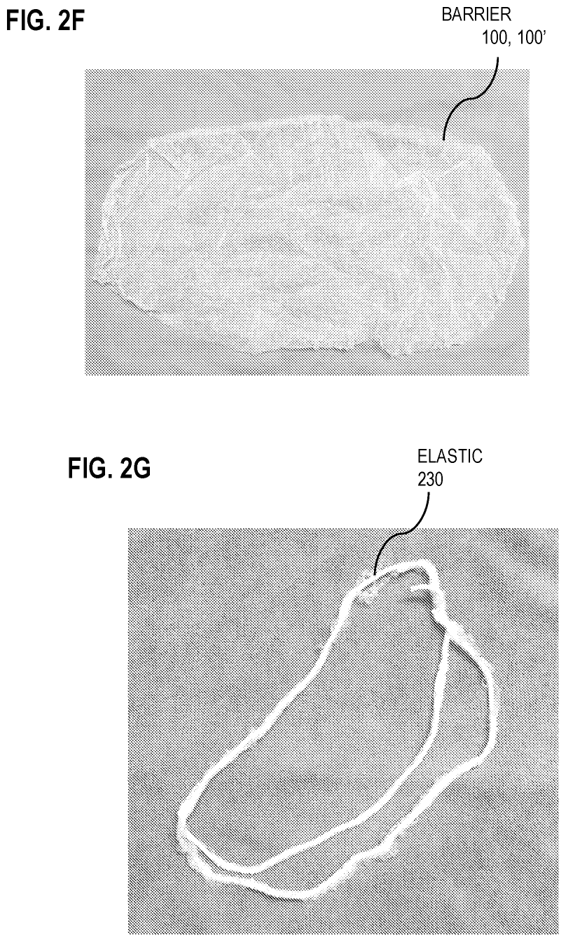

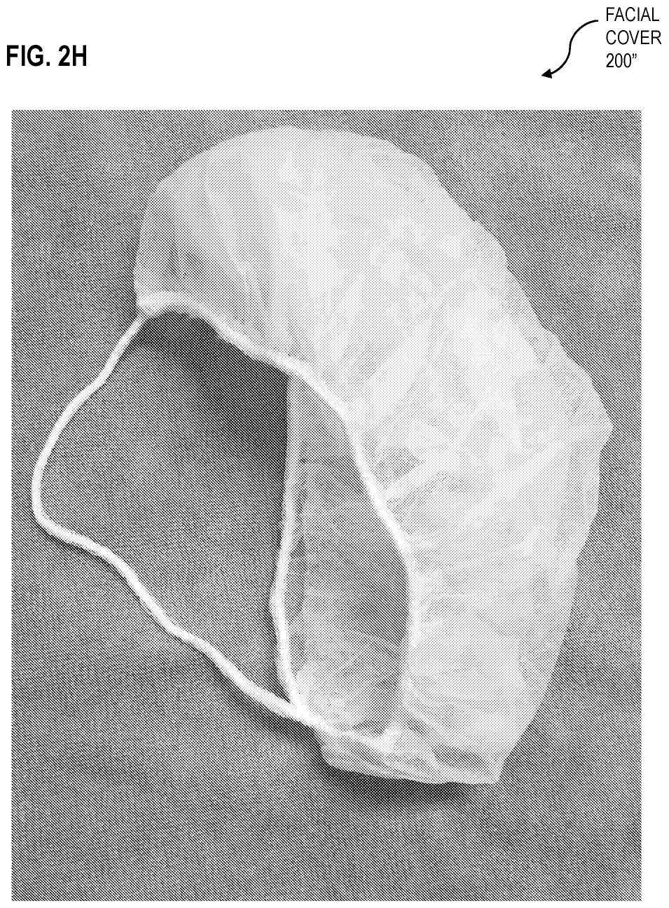

In one embodiment, the barrier 100, 100′ is used as a facial cover. FIG. 2A is an image that illustrates an example of a perspective view of the barrier 100, 100′ of FIG. 1A or 1B worn as a facial cover 200, according to an embodiment. In an example embodiment, the facial cover 200 includes the barrier 100, 100′ with dimensions sufficient to cover the face of the user 203 (e.g. mouth and nose). In an example embodiment, the height of the barrier 100, 100′ is about 10 cm and/or in a range from about 5 cm to about 20 cm and/or the width of the barrier 100, 100′ is about 21 cm and/or in a range from about 15 cm to about 25 cm and/or the thickness of the barrier 100, 100′ is about 3 mm and/or in a range from about 2 mm to about 4 mm and/or from about 0.5 mm to about 5 mm. These ranges of numerical dimensions for the barrier 100, 100′ are merely one example of ranges of these numerical dimensions and thus the numerical dimensions may be selected outside these ranges.

In this embodiment, the first region is external surroundings 202 of a user 203 of the facial cover 200. Thus, in this embodiment, the outer surface 108 of the first side 106 is directed toward the external surroundings 202 (see FIG. 2A). Also, in this embodiment, the second region 204 is the face of the user 203 (e.g. a region between the face of the user 203 and the facial cover 200). In this embodiment, the facial cover 200 includes the barrier 100, 100′ to prevent passage of the pathogen 110 from the external surroundings 202 to the user 203 (e.g. to prevent contamination of the user 203 by the external surroundings 202) and/or prevent passage of the pathogen 111 from the user 203 to the external surroundings 202 (e.g. to prevent contamination of the external surroundings 202 by the user 203).

In one embodiment, the facial cover 200 is secured to the face of the user 203 using ear loops 206. However, the embodiments of the present invention are not limited to this design. FIG. 2B is an image that illustrates an example of a perspective view of the barrier 100, 100′ of FIG. 1A or 1B worn as a facial cover 200′, according to an embodiment. In an embodiment, unlike the facial cover 200 of FIG. 2A that is attached to the face of the user 203 with ear loops 206, the facial cover 200′ of FIG. 2B is attached to the face of the user 203 by directly affixing or adhering the facial cover 200′ to the face of the user 203 (e.g. without ear loops 206). In one example embodiment, an adhesive 208 is provided on the outer surface 118 of the second side 116 such that the second side 116 is configured to be directly attached to the face of the user 203 with the adhesive 208. In an example embodiment, the adhesive 208 is a mixture of isopropanol and partially hydrogenated rosin, e.g. 80% and 20% by weight, respectively. In an example embodiment, as shown in FIG. 2B, the adhesive 208 is provided along a perimeter of the outer surface 118 of the second side 116 such that the adhesive 208 is configured to form an air-tight seal between the barrier 100, 100′ and the user 203 when the second side 116 is directly attached to the face of the user 203. In an example embodiment, the adhesive 208 is a strip having a width of about 1.5 cm and/or in a range from about 0.5 cm to about 2 cm along the perimeter. The inventors of the present invention recognized that the facial cover 200′ provides distinct advantages over the facial cover 200 with the ear loops 206, such as reducing the risk of infection by preventing air leaking around the edges of the barrier 100, 100′ when the user 203 inhales (reducing infection of user) or exhales (reducing infection of exterior surroundings). Additionally, other distinct advantages of the facial cover 200′ include increased comfort and not having to remove the ear loops 206 in certain situations (e.g. when getting a haircut) and other advantages (e.g. less fogging of glasses, etc.).

FIG. 2C is an image that illustrates an example of a cross-sectional view of the barrier 100, 100′ of FIG. 2A taken along the line 2C-2C. In an embodiment, FIG. 2C also depicts a cross-sectional view of the barrier 100, 100′ of FIG. 2B. The cross-sectional view of FIG. 2C is only taken along a portion of the height of the facial cover 200 (e.g. between a top and bottom of the facial cover 200 making contact with the user 203. As shown in FIG. 2C, in one embodiment the second region 204 is positioned between the face of the user 203 and the outer surface 118 of the second side 116. In an embodiment, as shown in FIG. 2C, the pathogen 210 is incident from the external surroundings 202 on the outer surface 108 of the facial cover 200 and thus the pathogenicidal components 112 coated on the outer surface 108 are configured to kill and/or deactivate the incident pathogen 210. In an embodiment, as shown in FIG. 2C, the pathogen 211 is incident from face of the user 203 on the outer surface 118 of the facial cover 200 and thus the pathogenicidal components 112 coated on the outer surface 118 are configured to kill and/or deactivate the incident pathogen 211.

In yet another embodiment, the facial cover can be attached to the user 203 using a fastener (e.g. elastic) that secures around the head of the user 203. FIGS. 2D and 2E are images that illustrates an example of a facial cover 200″ that is configured to secure to the face of the user 203 using a fastener (e.g. elastic 230). In an embodiment, as shown in FIG. 2D, the facial cover 200″ is oval shaped with a main radius 222 having a value of about 38 centimeters (cm) or in a range from about 30 cm to about 40 cm and a minor radius 224 of about 20 cm and/or in a range from about 15 cm to about 25 cm.

In another embodiment, as shown in FIG. 2E, the facial cover 200″ is circular shaped. In an embodiment, the elastic 230 is attached to two anchor points 232a, 232b of the facial cover 200″. In an example embodiment, the anchor points 232a, 232b are along a perimeter of the outer surface 118 that faces the user 203. In an example embodiment, a length of the elastic 230 is adjustable, so that the facial cover 200″ can fit a range of users 203. In another embodiment, the facial cover 200″ is secured to the user 203 by first positioning the outer surface 118 in close proximity to the face of the user 203 and then expanding the elastic 230 behind the head of the user 203 to hold the facial cover 200″ on the face of the user 203. FIGS. 2F through 2H show other images that illustrate an example of the barrier 100, 100′ used to make the facial cover 200″ (FIG. 2F); the elastic 230 used to secure the facial cover 200″ to the user 203 (FIG. 2G) and the facial cover 200″ with the attached elastic 230 (FIG. 2H).

Although the embodiments discussed with respect to FIGS. 2A through 2H disclose using the barrier 100, 100′ as a facial cover, the embodiments of the present invention are not limited to this arrangement. In other embodiments, a facial cover is provided that includes using the barrier 100, 100′ in conjunction with a conventional mask (e.g. N95). In these embodiments, the barrier 100, 100′ is used to reduce contamination of the conventional mask (e.g. by killing or deactivating incident pathogens on the mask) and thus advantageously extends the lifetime of the conventional mask.

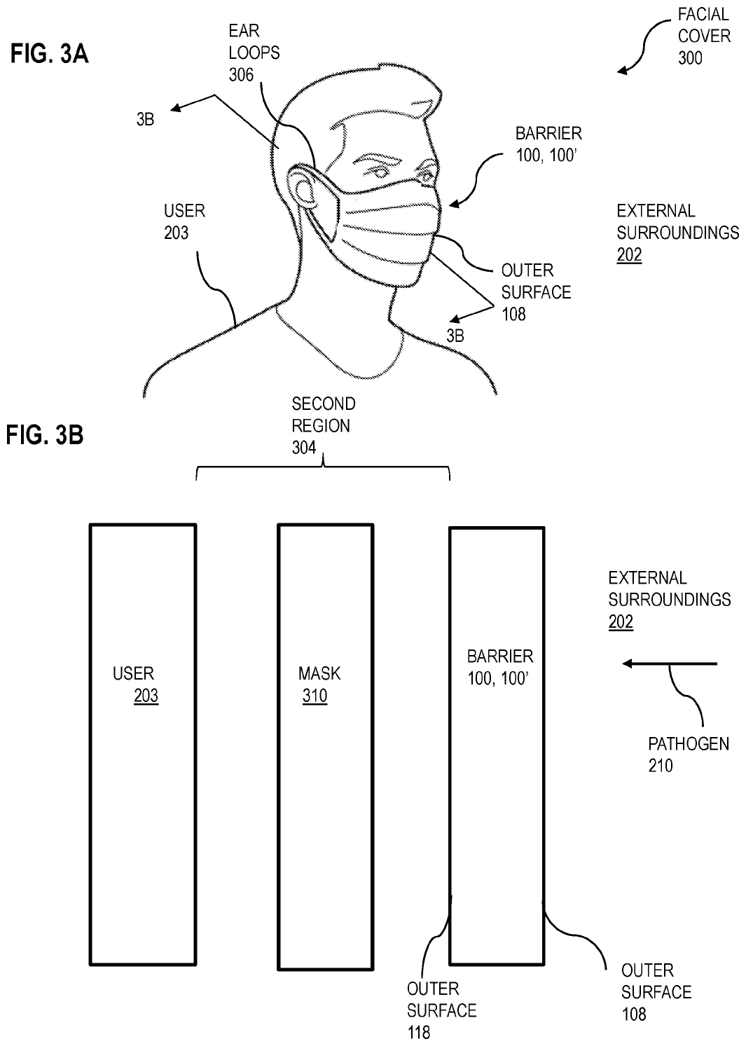

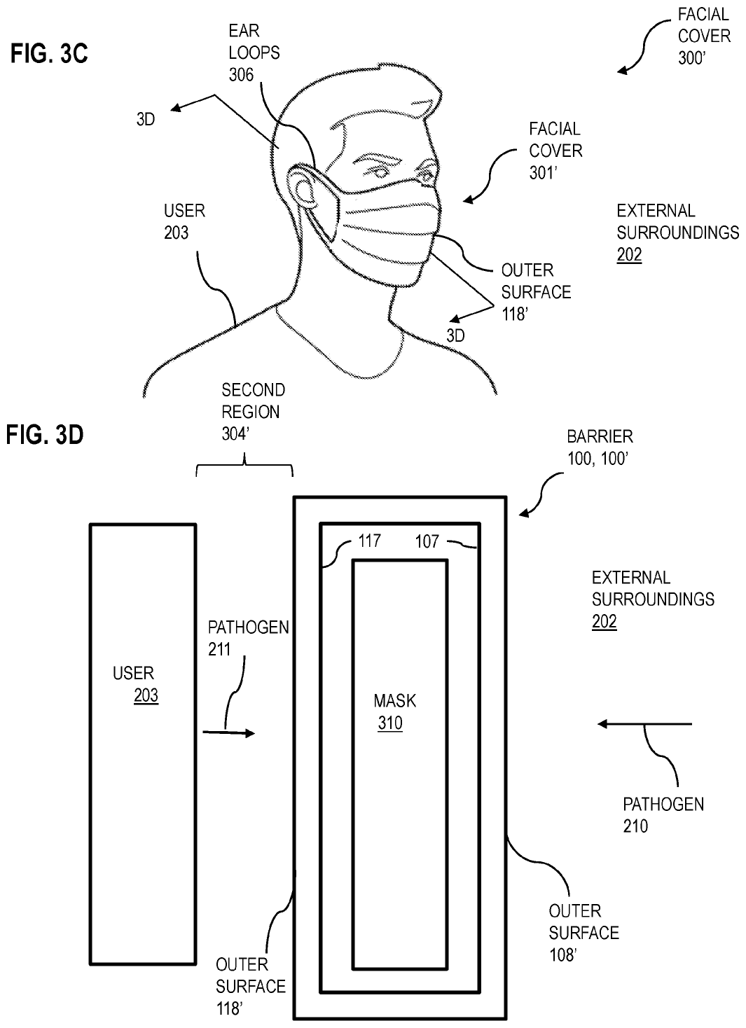

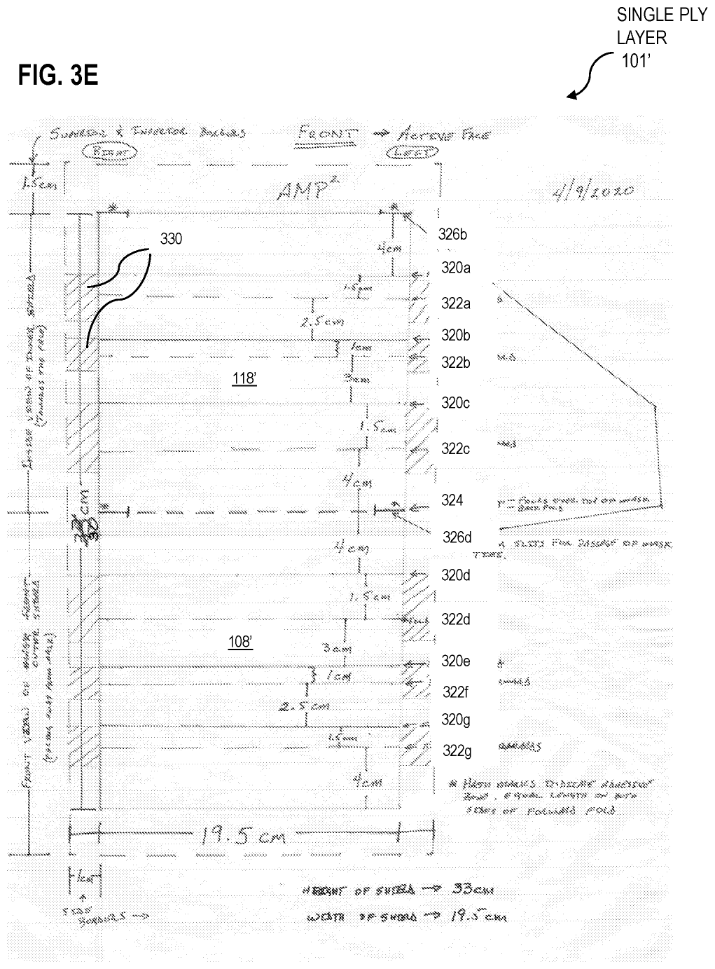

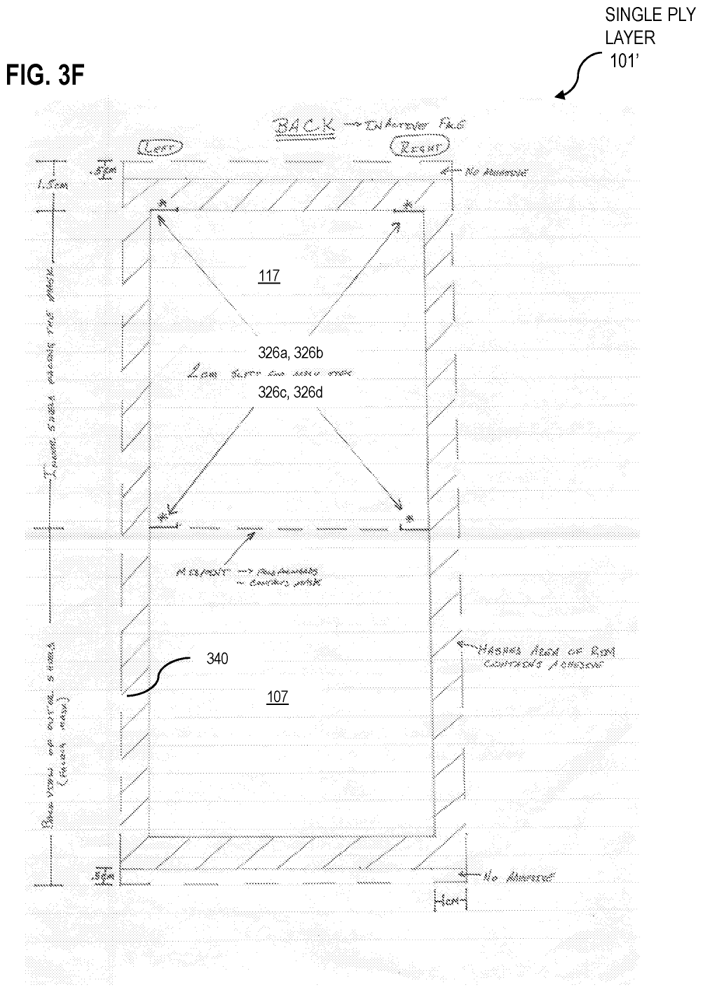

In one embodiment, the barrier 100, 100′ is used to over the outside of the conventional mask (e.g. the side of the mask facing the exterior surroundings of the user). In an example embodiment, the conventional mask 310 includes one or more untreated layers (e.g. that are not treated with pathogenicidal components) and thus are susceptible to surface contamination by pathogens. FIG. 3A is an image that illustrates an example of a perspective view of a facial cover 300 including the barrier 100, 100′ of FIG. 1A or 1B covering a mask 310, according to an embodiment. FIG. 3B is an image that illustrates an example of a cross-sectional view of the facial cover 301 of FIG. 3A taken along the line 3B-3B. As shown in FIG. 3A, the ear loops 306 are used to secure the conventional mask 310 to the face of the user 203. The barrier 100, 100′ is positioned on an outside of the conventional mask 310 (e.g. between the conventional mask 310 and the external surroundings 202) to prevent contamination of the conventional mask 310 by pathogens 210 (e.g. by killing or deactivating viral particles in an aerosol droplet) incident on the mask 310. In this embodiment, the outer surface 108 of the first side 106 of the barrier 100, 100′ is oriented towards the external surroundings 202. As shown in FIG. 3B, the conventional mask 310 is positioned within the second region 304 (e.g. between the user 203 and the barrier 100, 100′).

In another embodiment, the barrier 100, 100′ is used to enclose the conventional mask (e.g. cover both sides of the mask facing the external surroundings 202 and facing the user 203 when worn on the face). FIG. 3C is an image that illustrates an example of a perspective view of a facial cover 300′ including the barrier 100, 100′ of FIG. 1A or 1B enclosing a mask 310, according to an embodiment. FIG. 3D is an image that illustrates an example of a cross-sectional view of the facial cover 300′ of FIG. 3C taken along the line 3D-3D. Unlike the facial cover 300 of FIGS. 3A and 3B, the facial cover 300′ of FIGS. 3C and 3D includes the barrier 100, 100′ that covers both sides of the conventional mask 310 (e.g. the side of the conventional mask 310 facing the external surroundings 202 and the side of the conventional mask facing the user 203).

In still other embodiments, the barrier 100, 100′ encloses the conventional mask 310 (e.g. such that all surfaces of the conventional mask 310 are covered by the barrier 100, 100′). As shown in FIG. 3D, the barrier 100, 100′ encloses the conventional mask 310 such that the outer surface 108′ of the first side 106 is positioned to kill or deactivate pathogens 210 incident on the conventional mask 310 from the external surroundings 202 and the outer surface 118′ of the second side 116 is positioned to kill or deactivate pathogens 211 incident on the conventional mask 310 from the user 203 (e.g. breathed out through the mouth and/or aerosol droplets due to sneezing, etc.). Thus, the barrier 100, 100′ of FIG. 3D advantageously kills or deactivates pathogens 210, 211 incident on the conventional mask 310 from both regions 202, 304′, thereby minimizing the risk of contamination of the conventional mask 310 and thus extending the lifetime of the conventional mask 310.

In one embodiment, the barrier 100, 100′ is an integral barrier such that the outer surface 108′ and the outer surface 118′ are part of the same single piece of material. In other embodiments, the outer surface 108′ and the outer surface 118′ are from separate pieces of the barrier 100, 100′ and thus are not integral. In an example embodiment, where the outer surfaces 108′, 118′ are separate pieces of material, each of these outer surfaces 108′, 118′ are adhered to the conventional mask 310 (e.g. using an adhesive).

As discussed with respect to FIGS. 3C and 3D, in one embodiment, the barrier 100, 100′ is a single piece of integral material that encloses the conventional mask 310. FIGS. 3E and 3F are images that illustrate an example of a respective front view and rear view of this single ply layer 101′ prior to enclosing the mask 310. In an embodiment, FIGS. 3E and 3F depict the single ply layer 101′ of FIG. 3D prior to enclosing the conventional mask 310. In one embodiment, the single ply layer 101′ is folded around an edge (e.g. top edge) of the conventional mask 310 and fasteners are used to secure the single ply layer 101′ to itself around an opposite edge (e.g. bottom edge).

FIG. 3E depicts the outer surface 108′ and the outer surface 118′ of the barrier 100, 100′ (e.g., single ply layer 101) separated by a fold line 324 over which the single ply layer 101 is folded to enclose the conventional mask 310. Additionally, in an embodiment, spaced apart adhesive strips 330 are provided along respective sides of the outer surfaces 108′, 118′ such that the respective sides of the single ply layer 101 can adhere outside the sides of the conventional mask 310. Additionally, in an embodiment, multiple slits or openings 326a through 326d are provided adjacent the four corners of the outer surface 118′ through which the ear loops 306 of the conventional mask 310 are passed before securing behind the ears of the user 203. In yet another embodiment, multiple folds 320, 322 are provided along the outer surfaces 108′, 108′ with various spacings between the folds 320, 322 as shown (e.g. in a range from about 1.5 cm to about 4 cm). In an embodiment, a width of the outer surfaces 108′, 118′ is about 20 cm or in a range from about 15 cm to about 25 cm. In another embodiment, a height of the single ply layer 101 is about 33 cm or in a range from about 25 cm to about 40 cm.

FIG. 3F depicts the inner surface 107′ and the inner surface 117′ (FIG. 3D) of the barrier 100, 100′ (e.g., single ply layer 101) that respectively face the front and rear surfaces of the enclosed conventional mask 310 when the single ply layer 101 is folded to enclose the conventional mask 310. In an embodiment, the four openings 326a through 326d are also depicted in FIG. 3F through which the ear loops 306 are configured to extend. An adhesive 340 is provided along the perimeter of the inner surfaces 107′, 117′ such that the sides of the inner surfaces 107′, 117′ can self-adhere when the single ply layer 101 is folded to enclose the conventional mask 310.

Based on the previously disclosed embodiments, the barrier 100, 100′ allows users to reduce their exposure to infectious pathogens. In one embodiment, the barrier 100, 100′ is a pleated mask cover, with flexibility similar to a surgical mask, wraps around the user's mask 310, and provides a sealed environment with the aid of the adhesive 330, 340 to prevent contamination of the mask, and also has flexibility to fit to the user's face and allow a snug fit such as is required when using N95 and similar masks/respirators. The mask cover has slits 326a through 326d to allow the passage of straps when using a mask with that form factor, similar to a surgical mask. In another embodiment, the mask cover will also provide sealed protection if one is using a mask 310 with ear loops 306, or other methods used to fasten/secure to the user's head. In an example embodiment, the flaps for the adhesive seal are designed to peel away allowing the cover to be opened and remove the mask 310 without contaminating either the external or internal surfaces.

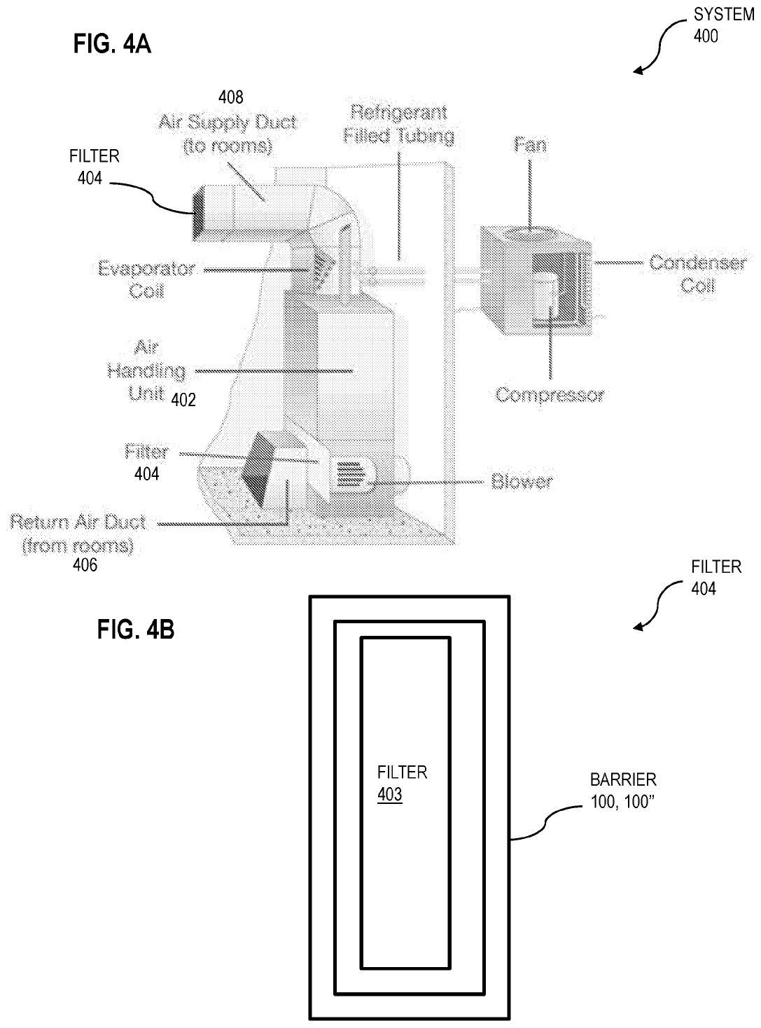

Although FIGS. 2A through 2H and FIGS. 3A through 3D discuss the barrier 100, 100′ being used in the context of facial covers, the embodiments of the present invention are not limited to this use of the barrier 100, 100′. In another embodiment, the barrier 100, 100′ is used in the context of air filters for air conditioning systems. The barrier 100, 100′ can advantageously be used to kill or deactivate pathogens that are present in the air circulated by air conditioning systems. FIG. 4A is an image that illustrates an example of a schematic diagram of the barrier 100, 100′ of FIG. 1A or 1B used as an air filter 404 in an air conditioning system 400, according to an embodiment. FIG. 4B is an image that illustrates an example of a schematic diagram of the air filter 404 of the air conditioning system 400 of FIG. 4A, according to an embodiment.

In one embodiment, the air filter 404 includes the barrier 100, 100′ discussed with respect to FIGS. 3D through 3F except the barrier 100, 100′ is sized and configured to enclose a conventional air filter 403 used in the air conditioning system 400 (rather than enclosing a conventional mask 310). In one example embodiment, the barrier 100, 100′ is used to enclose the air filter 403 positioned in the air handling unit 402 of the air conditioning system and thus advantageously kills or deactivates pathogens within air received through the return air duct 406. In this example embodiment, the first region 102 is the living space and the second region 104 is the air handling unit 402. In another example embodiment, the barrier 100, 100′ is used to enclose the air filter 403 (or attached to a vent or grate) positioned at an outlet of an air supply duct 408 (to rooms) and thus advantageously kills or deactivates pathogens within air prior to being discharged into a living space. In this example embodiment, the first region 102 is the air supply duct 408 and the second region 104 is the living space (e.g. room where air from the duct 408 is directed).

In an embodiment, although FIGS. 4A and 4B depict the air filter 404 (with the barrier 100, 100′) used in the air handling unit 402 of the air conditioning system 400 and at an outlet of the air supply duct 408, in some embodiments the air filter 404 is only used in one of the air handling unit 402 or the air supply duct 408. In still other embodiments, although FIG. 4B depicts that the filter 404 includes the barrier 100, 100′ enclosing a conventional air filter 403, in other embodiments the filter 404 is just the barrier 100, 100′ (e.g. secured to an outer frame with dimensions about equal to the conventional filter slot in the air handling unit 402 or dimensions of the air supply duct 408 at the outlet).

In yet another embodiment, although FIGS. 4A and 4B depict the barrier 100, 100′ used with air filter for air conditioning systems 400 used for residences or businesses, in still other embodiments the barrier 100, 100′ can be used for air conditioning systems of vehicles (e.g. cabin vehicles including but not limited to planes, trains and automobiles, etc.). In these embodiments, the barrier 100, 100′ can be used to enclose the existing conventional air filters in the air conditioning systems of these vehicles or can be positioned (without the conventional air filter) adjacent an outlet (or inlet) of the air conditioning system of the vehicle, to kill or deactivate pathogens in air circulated within the air conditioning system.

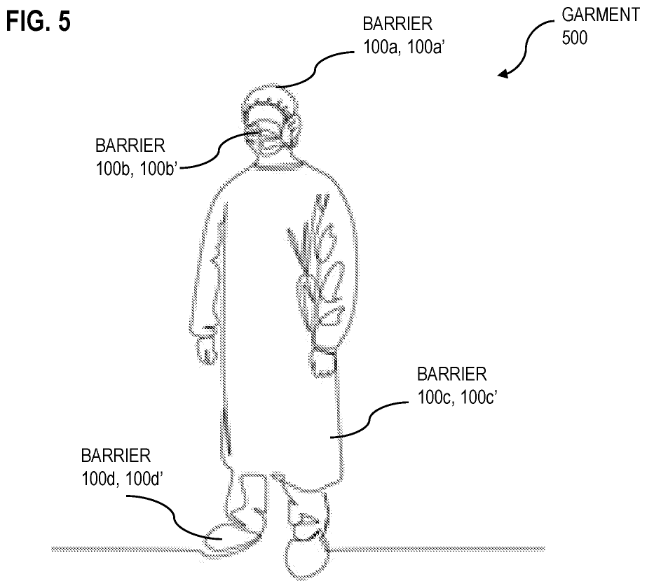

In one embodiment, another context where the barrier 100, 100′ can be used is in forming garments or clothing, particularly garments or clothing used in areas where pathogens are present (e.g. medical facility). In an example embodiment, the barrier 100, 100′ can be used to form garments worn by medical professionals (e.g. surgeons in a surgical room). In this example embodiment, the first region 102 is the external surroundings of the medical facility and the second region 104 is the body of the medical professional (e.g. covered by the garment). FIG. 5 is an image that illustrates an example of a schematic diagram of the barrier 100a through 100d of FIG. 1A or barrier 100a′ through 100d′ of FIG. 1B used to form a garment 500 worn by a medical professional (e.g. surgeon), according to an embodiment. In an example embodiment, the barrier 100a, 100a′ is used to form a head cover worn by the medical professional and/or the barrier 100b, 100b′ is used to form a facial cover worn by the medical professional and/or the barrier 100c, 100c′ is used to form a gown worn by the medical professional and/or the barrier 100d, 100d′ is used to form shoe covers worn by the medical professional. The inventors of the present invention recognized that using the single ply layers to form one or more garments worn by medical professionals would advantageously minimize the risk of infection or contamination of the medical professional by the external surroundings (and the external surroundings by the medical professional) while not affecting the level of comfort of the medical professional, due to the air permeability of the barrier 100, 100′. In an embodiment, the garment 500 is not limited to any particular garment (e.g. surgical gown) and includes isolation gowns (e.g. typically used in Intensive Care Unit (ICU) and can be single layer and relatively thin). In some example embodiments, surgical gowns employ multiple layer barriers 100′ in order to achieve ensure certain performance parameters (e.g. prevent passage of liquid contaminants).

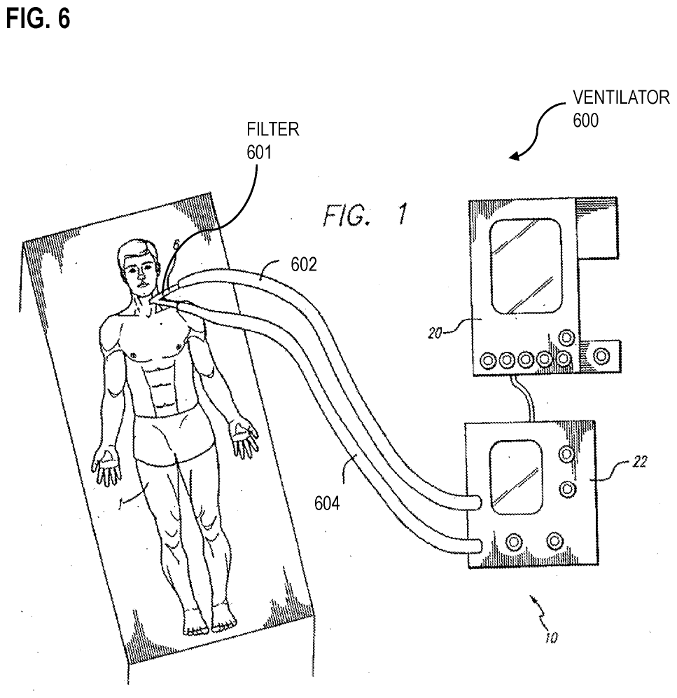

In one embodiment, another context where the barrier 100, 100′ can be used is for air filters used in ventilators. FIG. 6 is an image that illustrates an example of a schematic diagram of the barrier 100, 100′ of FIG. 1A or 1B used as a filter 601 in a ventilator 600, according to an embodiment. In this example embodiment, the first region 102 is an air supply duct 602 that directs air to the patient and the second region 104 is the patient. In yet another example embodiment, the first region 102 is the patient and the second region 104 is an air supply duct 604 that directs air from the patient to the ventilator 600.

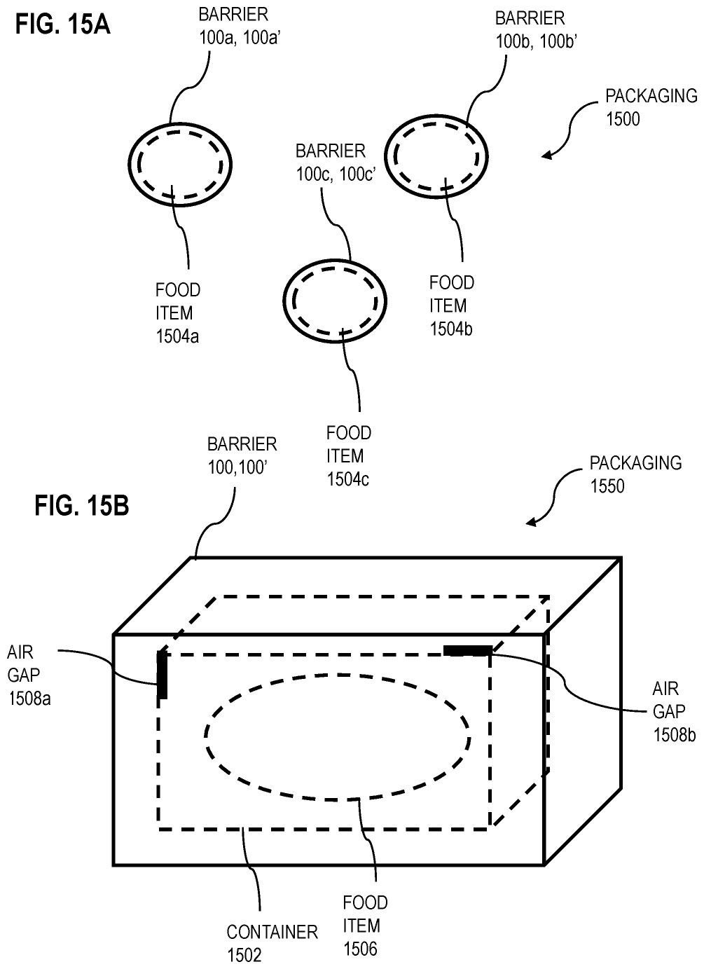

In one embodiment, another context where the barrier 100, 100′ can be used is protecting food items from being contaminated and/or spoiled by pathogens. FIGS. 15A and 15B are images that illustrate an example of a schematic diagram of the barrier 100, 100′ of FIG. 1A or 1B used to package food items, according to an embodiment. In some embodiments, as shown in FIG. 15A, packaging 1500 is provided with the barrier 100, 100′ being used to enclose individually wrapped food items 1504a, 1504b, 1504c (e.g. individually wrapped fruit). In this embodiment, each barrier 100, 100′ that encloses the respective food items 1504a, 1504b, 1504c prevents passage of pathogenicidal components 112 (e.g. bacteria, viruses, etc.) from the first region 102 (e.g. external environment of the food items 1504a, 1504b, 1504c) to the second region 104 (e.g. the area enclosed by the barrier 100, 100′ where the food items 1504a, 1504b, 1504c are positioned). In other embodiments, as shown in FIG. 15B, packaging 1550 is provided with the barrier 100, 100′ being used to enclose a container 1502 for the food item 1506 (e.g. shipping container, storage container of food items such as Ziploc® bag or Tupperware® container, etc.). As shown in FIG. 15B in some embodiments the container 1502 has air gaps 1508a, 1508b through which air can pass and make contact with the food item 1506, due to structural limitations of the container 1502. As shown in FIG. 15B the barrier 100, 100′ is used to enclose the container 1502 and thus advantageously prevents passage of pathogenicidal components 112 (e.g. bacteria, viruses, etc.) through the air gaps 1508a, 1508b which may contaminate or spoil the food item 1506.

### 2. First Method for Forming the Barrier

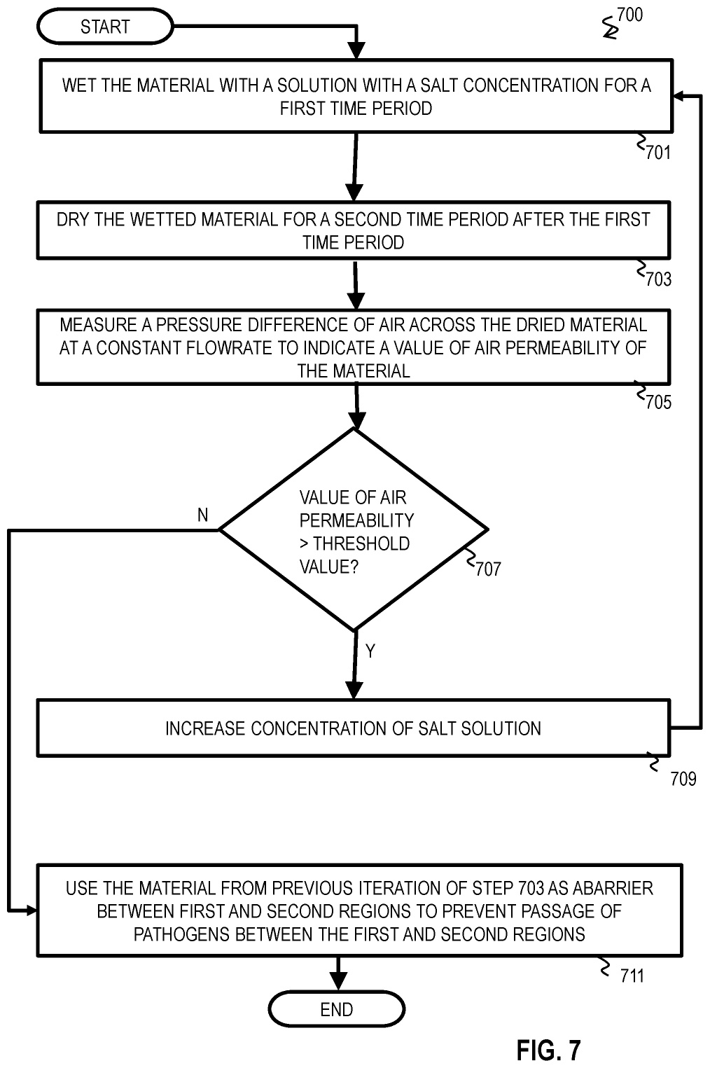

A method is now presented herein for forming the barrier 100, 100′. FIG. 7 is a flow chart that illustrates an example of a method 700 for forming the barrier 100, 100′ of FIG. 1, according to an embodiment. Although steps are depicted in FIG. 7 as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

In an embodiment, the method 700 is configured to form the material of the barrier 100, 100′ in order to optimize one or more design parameters of the barrier 100, 100′. In one embodiment, one of the design parameters is the efficiency of the pathogenicidal components 112 in killing or deactivating pathogens. The inventors recognized that this efficiency is based on the concentration of pathogenicidal components 112 used in forming the barrier 100, 100′. In an example embodiment, where salt is employed as the virucidal components 112, this efficiency is based on a level of crystallization (LOC) of the salt. Another design parameter is the air permeability of the barrier 100, 100′, which affects the comfort of the user (e.g. breathability) wearing the facial cover including the barrier 100, 100′. Thus, in an embodiment, the method 700 is configured to optimize these two parameters (e.g. killing or deactivation efficiency of pathogens and breathability) of the barrier 100, 100′. The inventors of the present invention understood that varying one of the parameters may affect the other parameter. In an example embodiment the inventors of the present invention understood that increasing the level of concentration of the pathogenicidal components 112 (or level of crystallization of the salt) may decrease the air permeability (and thus the breathability) of the facial cover employing the barrier 100, 100′. Thus, in an example embodiment, the method 700 is employed to optimize values of these parameters in order to design the barrier 100, 100′ with a sufficient concentration of pathogenicidal components 112 to efficiently kill or deactivate the pathogens while simultaneously ensuring an adequate air permeability (and thus breathability).

In an embodiment, one or more sheets of material are used to form the barrier 100, 100′ (e.g. with a width and length of about 40 cm by 40 cm and/or with a width and length in respective ranges from about 10 cm to about 50 cm). In one example embodiment, the sheet(s) of material is a thermo plastic material (e.g. polypropylene) and/or cotton blend (e.g. silk, wool, cotton, etc.).

In an embodiment, step 701 includes wetting material with a solution including pathogenicidal components with a concentration of a particular value. In one embodiment, the wetting of step 701 is performed over a first time period (e.g. about 20 hours). In an example embodiment, the solution has a salt concentration (e.g. in a range from about 0.02 ml/cm² to about 0.06 ml/cm² and/or in a range from about 0.01 ml/cm² to about 0.1 ml/cm² of salt).

In another embodiment, step 701 includes applying the pathogenicidal components (e.g. virucidal and/or bactericidal components) to the material and includes one or more of misting, spraying, sputtering, painting or soaking/submerging (e.g. for liquid components) and pelleting or powdering (e.g. for solid components) and applied in a dry coat, rolled, aerially dispersed, dry-sputtered, evaporated, pressured, and vacuum incorporated. In an example embodiment, dry powders may be ground into nanoparticles or suspended and emulsified in a liquid for applications to coat the mask cover. Gels and oils may be applied a liquid coating.

In an embodiment, step 701 includes submerging the material in a tank with the solution for the first time period such that the material is fully submerged and/or uniformly spraying the material with the solution and/or injecting, from an injectable platform, the solution into the material. In an example embodiment, step 701 includes submerging the material in a tank with a volume (e.g. about 34 mL) of solution for the first time period (e.g. about 12 hours) to transform hydrophobic properties and increase wetting/absorption, which is considered the pre-wetting process. In this example embodiment, a remaining volume (e.g. about 68 mL) is applied in the same manner prior to the drying step 703. In another example embodiment, the material is fully submerged in the tank of solution during the wetting step 701. It should be noted that the particular values of the parameters of the submerging discussed above (e.g. time period for the step 701, size of the material, volume of solution, etc.) can be adjusted based on the purpose of the material (e.g. facial cover, air filter, garment/apparel, food packaging, etc.).

In an embodiment, step 701 includes spraying the material placed in a petri dish or a plate of a necessary size (e.g. about 40 cm by 40 cm). In this embodiment, for all intents and purposes), the spraying step is performed using a jet or mist spray, and the solution is uniformly spread over the material. In an example embodiment, the first time period is about the same (e.g. about 12 hours) as for the submerging step. In an example embodiment, a volume of spray solution utilized in the spraying step is about 0.90 mL. In another example embodiment, a spray diameter used during the spraying step is about 15.5 cm when placed about 20 cm away from the material. It should be noted that the particular values of the parameters of the spraying discussed above (e.g. time period for the step 701, size of the material, volume of solution, volume of spray, etc.) can be adjusted based on the purpose of the material (e.g. facial cover, air filter, garment/apparel, food packaging, etc.). It should be noted that the particular values of the parameters of the spraying discussed above (e.g. time period for the step 701, size of the material, volume of spray, diameter of spray, etc.) can be adjusted based on the purpose of the material (e.g. facial cover, air filter, garment/apparel, food packaging, etc.).

In an embodiment, step 701 includes injecting the material with the solution. In this embodiment, the injecting is performed using an injectable platform and syringe needles with a gauge in a certain range (e.g. from about gauge 28 to about gauge 32 with an inner diameter ranging from about 0.18 mm to about 0.11 mm). In an example embodiment, the active wetting area is about 2.7 mm. In another embodiment, the needles are aligned on a platform of width equal (e.g. about 40 cm) to the sheet of material. In an example embodiment, the solution is equally divided to penetrate, inject, and impregnate material immediately with no prewetting time. In an example embodiment, step 701 involves about 22,500 syringes each delivering about 0.004 mL in one step, thus eliminating the need for a pre-wetting step. In another example embodiment, the volume is well above the dead volume of needles that size, allowing optimal priming of each syringe.

In an embodiment, step 703 including drying the wetted material from step 701 for a second time period (e.g. about 10 hours or in a range from about 8 hours to about 15 hours) after the first time period. In one embodiment, step 703 is performed in one of an oven or an airtight vessel, where the second time period for the drying step in the airtight vessel is less than the second time period for the drying step in the oven. In an example embodiment, in step 703 the drying may be undertaken at a temperature in a range from about 20 degrees C. to about 100 degrees C., and sterilization may be performed with either heat (e.g. from about 20 degrees C. to about 100 degrees C.) or with gas sterilization.

In an embodiment, the drying step 703 involves conventional drying, where the material is placed in a conventional oven of uniform temperature and throughout brought by a fan in the rear. In this embodiment, the drying step 703 is performed for about 24 hours. In another embodiment, the drying step 703 involves vacuum drying performed in an airtight vessel, where the relative humidity and pressure are drastically reduced. In this example embodiment, with the atmospheric pressure lowered, materials can dry much more rapidly. In an example embodiment, the boiling point of water significantly decreases (e.g., from about 100 degrees to about 35 degrees C.), as a result the rate of evaporation increases, allowing drying that would take 24 hours at atm to take place within hours, depending on the specific conditions set.

In an embodiment, step 705 includes measuring an air permeability of the material after step 703. In one embodiment, the measuring of the air permeability includes measuring an air pressure difference across the material after step 703 based on a constant flowrate across the material.

In an embodiment, step 707 includes comparing the value of the air permeability measured in step 705 with a threshold value of air permeability (e.g. corresponding to an air pressure difference equal to or less than 0.2 mm H₂0/cm²). If the measured value of the air permeability from step 705 is greater than the threshold value, the method 700 moves to block 709. If the measured value of the air permeability from step 705 is not greater than the threshold value, then the method 700 moves to block 711.

In an embodiment, step 709 includes increasing the concentration of the pathogenicidal components 112 in the solution (e.g. increasing the concentration of salt in the solution) and then repeating steps 701 through 707 for the increased concentration value of the solution.

In an embodiment, step 711 includes using the material from the previous iteration of step 703 as the barrier 100, 100′. In one embodiment, where a multiple layer 101a, 101b barrier 100′ is used in step 711, the method 700 (e.g. steps 701 through 709) are repeated to form each respective layer 101a, 101b of the multiple layer barrier 100′ which is then used in step 711. In one embodiment, steps 701 through 707 are repeated provided that the measured air permeability is greater than the threshold value of air permeability. Once step 707 indicates that the value of the air permeability is less than the threshold value of the air permeability, this indicates that the concentration of the pathogenicidal components 112 is too high and thus adversely affecting the air permeability. Thus, the concentration of the pathogenicidal components 112 in the previous iteration of steps 701 through 707 is utilized in step 711 to form the barrier 100, 100′. In an example embodiment, if the fourth iteration of steps 701 through 707 indicates that the measured air permeability is less than the threshold value, then the value of the concentration used in the third iteration of steps 701 through 707 is employed in step 711 to form the barrier 100, 100′. This concentration of pathogenicidal components 112 advantageously provides an effective balance between a high concentration of pathogenicidal components 112 (e.g. to maximize the killing or deactivation of the pathogens) while still ensuring an acceptable level of air permeability. The inventors of the present invention found a surprising result-despite four iterations of steps 701 through 709 and four consecutive increases in the salt concentration of the solution, the measured air permeability exceeded the threshold value in step 707 for each iteration. This is a surprising result since the inventors expected that an increase the salt concentration of the solution would cause reduced air permeability (e.g. since the increased concentration of salt crystals were expected to partially cover some of the pores). Thus, in one embodiment, the inventors performed the method 700 and utilized the highest concentration value among four consecutive increases (four iterations of steps 701 through 709). In one example embodiment, increasing values of the salt concentration used during the four iterations of steps 701 through 709. In an example embodiment, these increasing values of concentration for each iteration of steps 701 through 709 include 0.02122 ml/cm², 0.03182 ml/cm², 0.04244 ml/cm² and 0.06367 ml/cm². However, these example values of the salt concentration are just one example of values and the values of the salt concentration employed in the method herein are not limited to these particular values or these particular range of values.

The treated material with the virucidal components (from steps 701 and 703) has certain properties and characteristics. In an embodiment, due to the application of the solution to the polypropylene sheet (step 701), the material exhibits certain properties and characteristics that differ drastically from the bare sheet utilized in current conventional masks 310 (e.g. conventional surgical masks). Contact Angle (Θ_{C}) is defined as a quantity measuring ability of a liquid to the wet the surface of a solid. In addition to the formation of salt crystals in the material (e.g. NaCl crystals) on the material (e.g. polypropylene fibers), the presence of surfactant altered the surface properties from hydrophobic (e.g. Θ_{C} is about) 134±5° to hydrophilic (e.g. Θ_{C} is about) 0°. As a result, the adhesion of viral aerosols to the fibers is greatly improved.

In one embodiment, during use of the barrier 100, 100′ formed by the method 700, once the outer surface 108, 118 is exposed to virus aerosols, the salt crystals at the point of contact dissolve and gradually increase the osmotic pressure in the viral cells. In this embodiment, evaporation takes place, causing the salt concentration to shift from the higher concentration of the barrier 100, 100′ into the virus eventually leading to the oversaturation of the cell. Once the solubility limit is reached, recrystallization of the salt commences. During drying, viruses and bacterial cells are exposed to even more osmotic pressure, eventually reaching hyperosmotic stress (e.g. about >541 mOsm). The combination of crystallization and intercellular stress, prompts irreversible deformation of the viral envelope and overall structural damage causing infectivity loss of the virus.

### 3. Second Method for Forming the Barrier

Unlike the first method 700 for forming the barrier 100, 100′ that is disclosed in FIG. 7, where one or more sheets of material are formed before pathogenicidal components (e.g. salt) are added to the material, in other embodiments a second method is provided where pathogenicidal components are incorporated or integrated into one or more sheets of material (e.g. non-woven polymer fabric) as the sheet of material is being formed. The inventors of the present invention recognized that the second method provides notable advantages, such as a significantly reduced time (e.g. less than 1 hour) to form the barrier 100, 100′ with the pathogenicidal components 112.

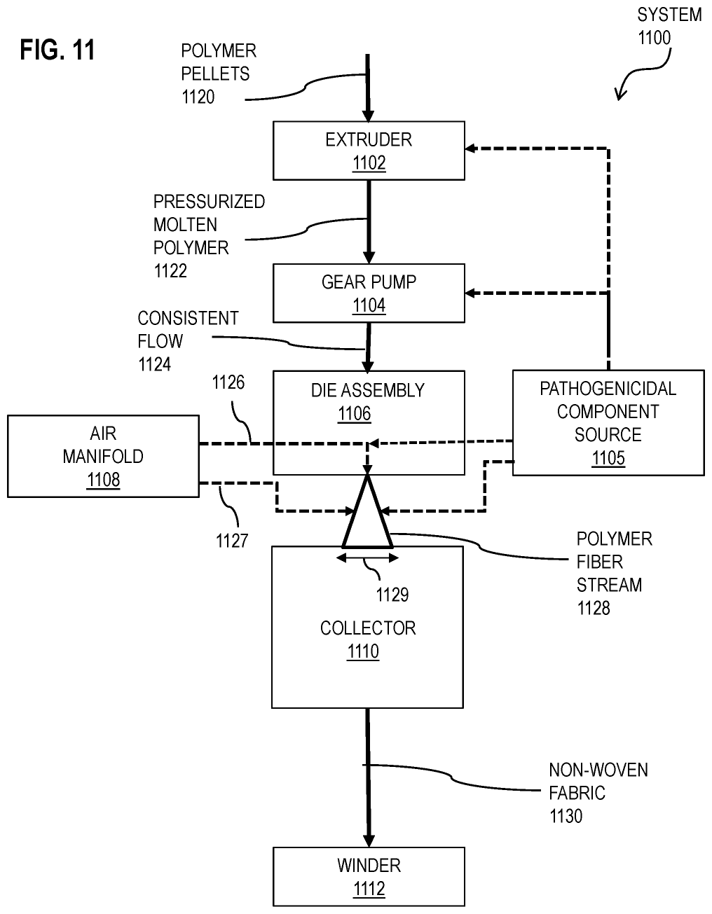

A system that is used to perform the second method is now discussed herein. FIG. 11 is a block diagram that illustrates an example of a system 1100 to form non-woven fabric of the barrier 100, 100′ of FIG. 1A or 1B, according to an embodiment. In some embodiments, the system 1100 is used to form the barrier 100, 100′ using melt-blowing, where each layer 101 of the barrier 100, 100′ is integrated or incorporated with pathogenicidal components 112 as each layer 101 is formed (e.g. layer 101 of the barrier 100 or layers 101a, 101b of the barrier 100′). However, in other embodiments, a system can be used to form the barrier 100, 100′ and incorporate/integrate the pathogenicidal components 112 into the barrier 100, 100′ using a method other than melt-blowing.

In an embodiment, the method disclosed herein involves melt blowing. Melt blowing is a conventional fabrication method of micro- and nanofibers where a polymer melt is extruded through small nozzles surrounded by high speed blowing gas. The randomly deposited fibers form a nonwoven sheet product applicable for filtration, sorbents, apparels and drug delivery systems. The substantial benefits of melt blowing are simplicity, high specific productivity and solvent-free operation. Some of the polymers used to produce melt blown fabric include, Polypropylene, Polystyrene, Polyesters, Polyurethane, Polyamides (nylons), Polyethylene, Polycarbonate, Polylactic Acid (PLA) to name a few. Nonwoven melt-blown fabrics are porous. As a result, they can filter liquids and gases. Their applications include water treatment, masks, and air-conditioning filters. Nonwoven materials can retain liquids several times their own weight. Melt-blown fabrics have three qualities that help make them useful for clothing, especially in harsh environments: thermal insulation, relative moisture resistance and breathability. The inventors of the present invention recognized that an improved melt blowing method could be used, with the additional step of introducing pathogenicidal components 112 (e.g. salt) into the polymer material (e.g. into an air stream utilized in the melt blowing process), so that it is incorporated into the fabric as it is produced, negating the need for a secondary process of adding a salt solution to the finished fabric and then drying the fabric to form a crystalline structure within the fabric. This formed fabric is used to form the one or more layers 101 of the barrier 100, 100′.

As shown in FIG. 11, in one embodiment the system 1100 includes an extruder 1102. In these embodiments, polymer pellets 1120 or granules are fed into the extruder 1102. The polymer pellets 1120 are conveyed along the extruder 1102 whose surfaces are heated such that the polymer pellets 1120 melt. The melted polymer material is then pressurized such that the extruder 1102 outputs pressurized molten polymer 1122.

In an embodiment, the system 1100 also includes a gear pump 1104 which receives the pressurized molten polymer 1122 from the extruder 1102. The gear pump 1104 subsequently discharges a consistent flow of pressurized molten polymer 1124.

In an embodiment, the system 1100 also includes a die assembly 1106 which receives the consistent flow of pressurized molten polymer 1124 from the gear pump 1104. In one embodiment, the die assembly 1106 extrudes polymer filament strands through holes in a spinneret (not shown) of the die assembly 1106 based on the pressurized molten polymer 1122 received from the gear pump 1104.

In an embodiment, the system 1100 also includes an air manifold 1108 (e.g. air compressor) to supply a flow of air to attenuate the polymer filament strands output from the die assembly 1106 into a stream of polymer fibers 1128. In one example embodiment, the flow of air is a primary air flow 1126 that is high velocity and is directed within the die assembly 1106 (e.g. within a slot defined by the die assembly 1106) after which the primary air flow 1126 attenuates the polymer filament strands into the stream of polymer fibers 1128. In another example embodiment, the flow of air is a secondary air flow 1127 that is low velocity (e.g. a velocity lower than the primary air flow 1126) and is directed downstream of the outlet of the die assembly 1106 where the secondary air flow 1128 attenuates the polymer filament strands into the stream of polymer fibers 1128. In some embodiments, both the primary air flow 1126 and the secondary air flow 1127 are employed to attenuate the polymer filament strands into the stream of polymer fibers 1128.

In an embodiment, the system 1100 also includes a collector 1110 (or conveyor) with a surface onto which the stream of polymer fibers 1128 are directed to form a non-woven fabric (not shown). In an embodiment, the non-woven fabric is used to form the layer 101 of the barrier 100 or the multiple layers 101a, 101b of the barrier 100′. In one embodiment, the stream of polymer fibers 1128 are directed over a width 1129 of the collector 1110 such that the non-woven fabric formed on the collector 1110 has the width 1129. In an example embodiment, the width 1129 varies based on the system 1100 and/or parameters of the system 1100 (e.g. a separation between the die assembly 1106 and the collector 1110).

In an embodiment, the system 1100 includes a device configured to introduce the pathogenicidal components 112 into the polymer material at one or more locations along the system 1100. In one embodiment, the device is a pathogenicidal component source 1105 and is configured to introduce the pathogenicidal components 112 into one or both of the primary air flow 1126 or secondary air flow 1127 such that the pathogenicidal components 112 are introduced into the stream of polymer fibers 1128 upstream of the collector 1110. In other embodiments, the pathogenicidal component source 1105 is configured to introduce the pathogenicidal components 112 at a location in the system 1100 more upstream, such as in the consistent flow of pressurized molten polymer 1124 (e.g. at or downstream of the gear pump 1104) or in the pressurized molten polymer 1122 (e.g. at or downstream of the extruder 1102). In these embodiments, the pathogenicidal component source 1105 is configured to introduce the pathogenicidal components 112 into the system such that the polymer material is sufficiently malleable that the pathogenicidal components 112 adhere to the polymer material. In an example embodiment, where the pathogenicidal component source 1105 is configured to introduce the pathogenicidal components 112 into the primary air flow 1126 or secondary air flow 1127, the stream of polymer fibers 1128 is sufficiently malleable that the pathogenicidal components 112 adhere to the stream of polymer fibers 1128. The inventors recognized that this feature of the method is advantageous as it ensures that the non-woven fabric formed on the collector 1110 features a non-woven fabric of the polymer fibers with embedded or integrated pathogenicidal components 112 therein (which can then be used to form the one or more layer 101 of the barrier 100, 100′). Hence, the inventors of the present invention recognized that this advantageous step obviates the need to first form the non-woven fabric followed by a separate time consuming step of coating the formed non-woven fabric with pathogenicidal components 112.

In an embodiment, the system 1100 includes a winder 1112 that is used to collect (e.g. wind up) the formed non-woven fabric on the collector 1110 with the integrated or embedded pathogenicidal components 112. In an example embodiment, the winder 1112 is rotatable such that it forms a spool of the non-woven fabric that can be then used to form various layers 101 of the barrier 100, 100′ previously disclosed (e.g. facial cover, air filter, PPE equipment, clothing or gown material for medical professionals, food packaging, etc.).

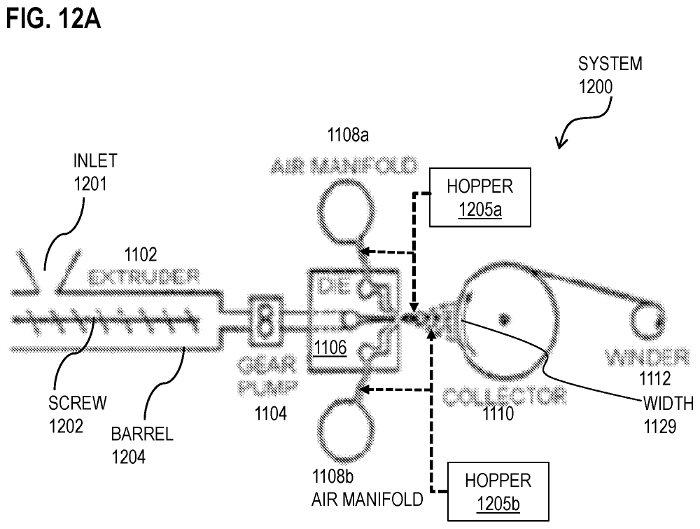

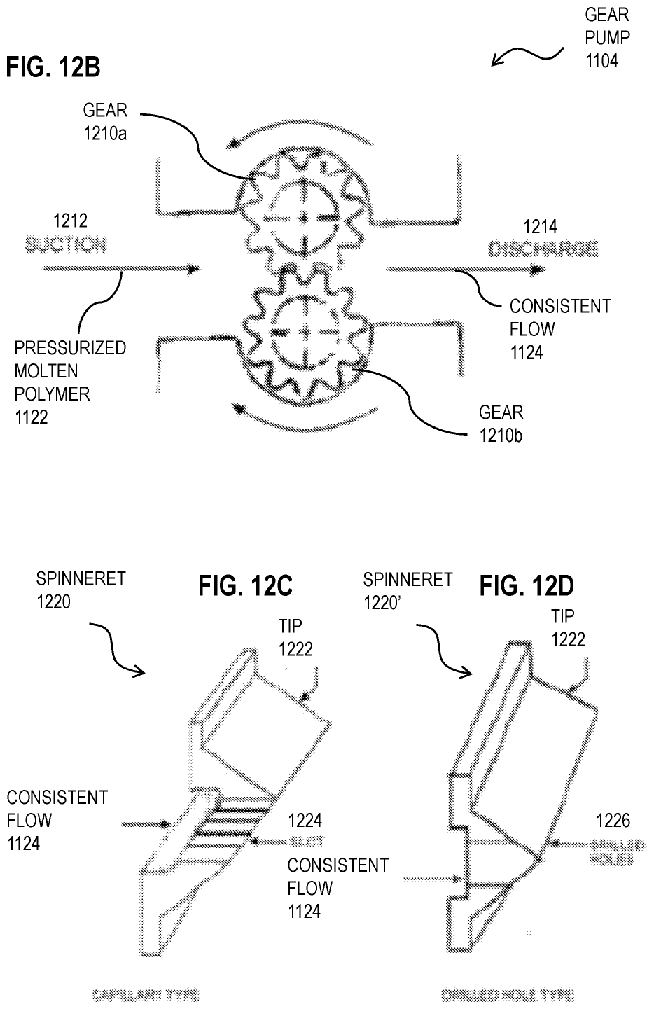

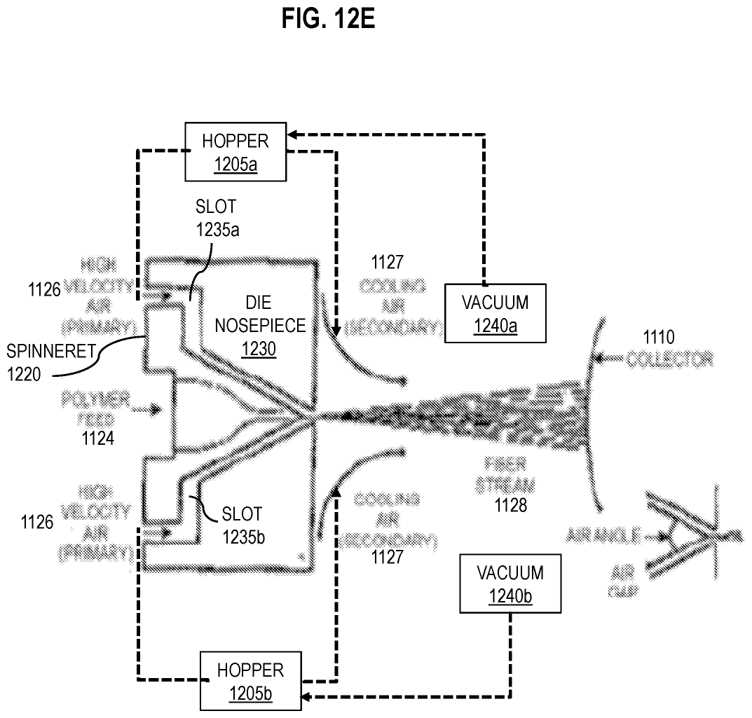

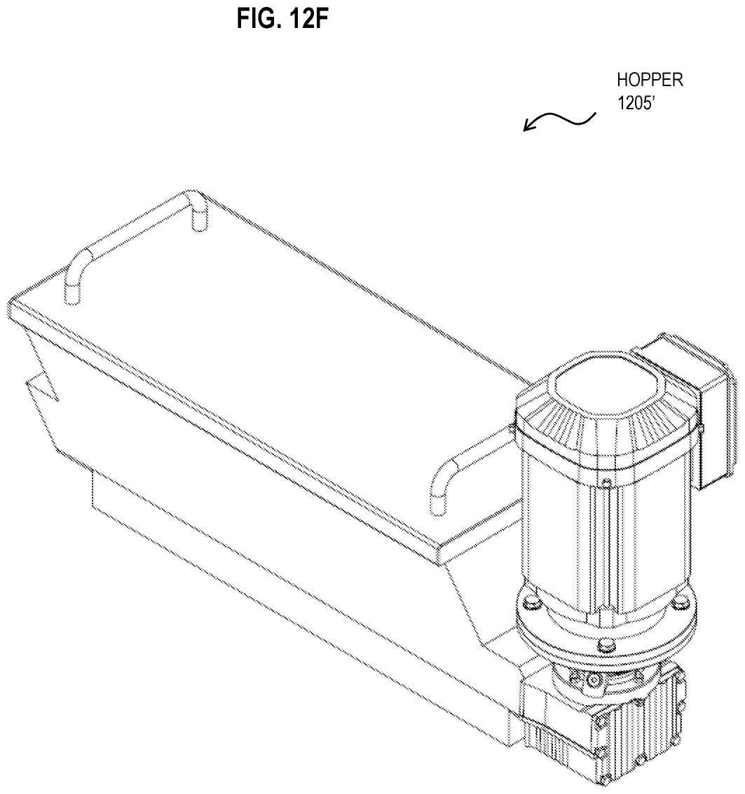

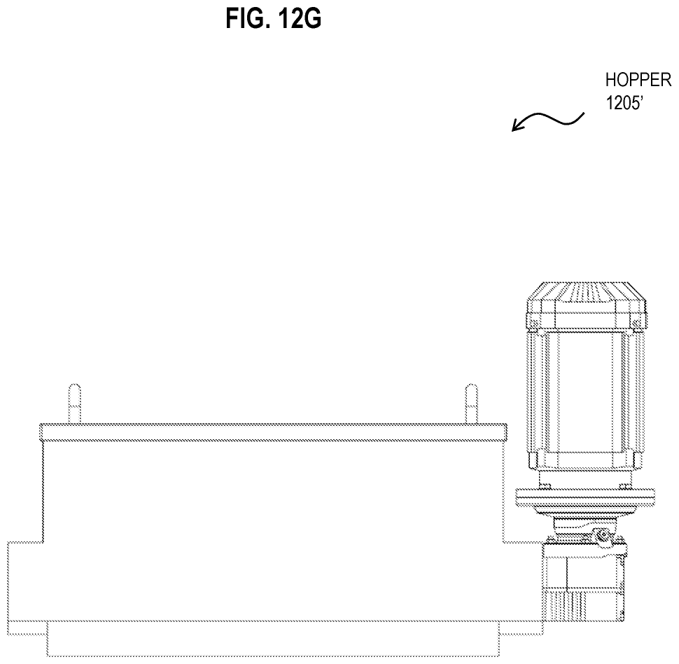

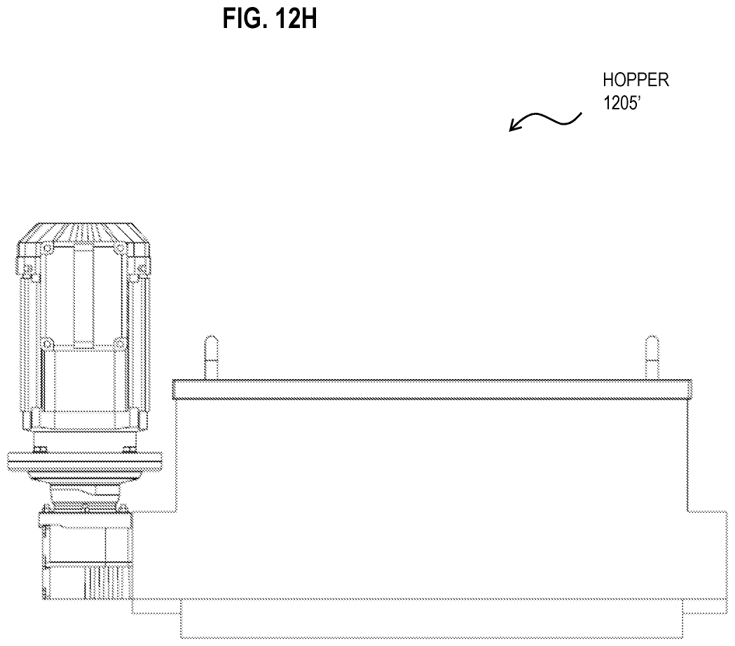

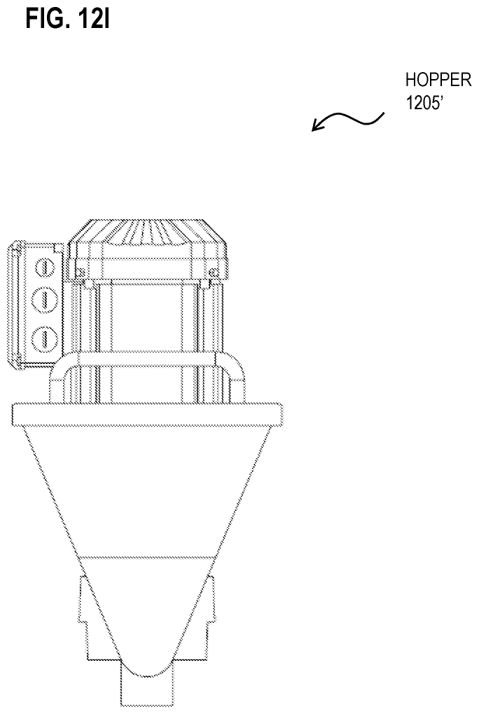

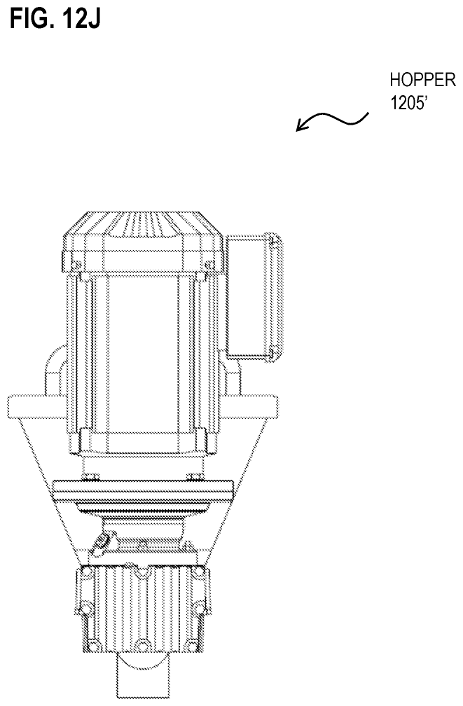

FIGS. 12A through 12E are schematic diagrams that illustrates an example of a system 1200 to form the barrier 100, 100′ of FIG. 1A or 1B, according to an embodiment. The system 1200 is similar to the system 1100 of FIG. 11, with the exception of the features discussed herein.

In an embodiment, the system 1200 includes the extruder 1102 with an inlet 1201 through which the polymer pellets 1120 are gravity fed into a heated barrel 1204 that houses a screw 1202. The screw 1202 rotates within the heated barrel 1204. The pellets 1120 are conveyed forward along hot walls of the barrel 1204 between the flights of the screw 1202, as shown in FIG. 12A. As the polymer pellets 1120 moves along the barrel 1204, they melt due to the heat and friction of viscous flow and the mechanical action between the screw 1202 and the barrel 1204. In an example embodiment, the screw 1202 is divided into feed, transition, and metering zones. The feed zone preheats the polymer pellets 1120 in a deep screw channel and conveys them to the transition zone. The transition zone has a decreasing depth channel in order to compress and homogenize the melting polymer. The molten polymer is discharged to the metering zone, which serves to generate maximum pressure for extrusion. The pressure of molten polymer is highest at this point and is controlled by a breaker plate (not shown) with a screen pack placed near the screw discharge. The screen pack and breaker plate also filter out dirt and infused polymer lumps. The pressurized molten polymer 1122 is then conveyed to the gear pump 1104.

In an embodiment, the system 1200 includes the gear pump (or metering pump) 1104 that is a positive-displacement and constant-volume device for uniform melt delivery to the die assembly 1106. In one embodiment, the gear pump 1104 ensures consistent flow of clean polymer mix under process variations in viscosity, pressure, and temperature. The gear pump 1104 also provides polymer metering and the required process pressure. As shown in FIG. 12B, in one embodiment the metering gear pump 1104 has two intermeshing and counter-rotating toothed gears 1210a, 1210b. In these embodiments, the positive displacement is accomplished by filling each gear tooth with polymer on the suction side 1212 of the pump and carrying the polymer around to the pump discharge 1214, as shown in FIG. 12B. The pressurized molten polymer 1122 is output from the gear pump 1104 as the consistent flow of pressurized molten polymer 1124. In some embodiments, the consistent flow of pressurized molten polymer 1124 goes to a feed distribution system to provide uniform flow to the spinneret of the die assembly 1106 (or fiber forming assembly).

In an embodiment, the system 1200 includes the die assembly 1106 that has one or more distinct components. In one embodiment, these distinct components include a polymer feed distribution (not shown), a spinneret 1220 (FIGS. 12C through 12E) and one or more air manifolds 1108a, 1108b (FIG. 12A).

In an embodiment, the feed distribution (not shown) of the die assembly 1106 usually has no mechanical adjustments to compensate for variations in polymer flow across the die assembly 1106 width. In another embodiment, the system 1200 is often operated in a temperature range where thermal breakdown of polymers proceeds rapidly. Thus, in some embodiments, the feed distribution is usually designed in such a way that the polymer distribution is less dependent on the shear properties of the polymer. This feature allows the melt blowing of widely different polymeric materials with one distribution system. The feed distribution balances both the flow and the residence time across the width of the die assembly 1106. In an embodiment, there are two types of feed distribution that have been employed in the melt-blown die assembly 1106: a T-type (e.g., tapered and non-tapered) and a coat hanger type. In some embodiments, the coat hanger type feed distribution is widely used because it gives both even polymer flow and even residence time across the full width of the die assembly 1106.

As shown in FIG. 12E, the feed distribution channel the consistent flow of pressurized molten polymer 1124 goes directly to the spinneret 1220 of the die assembly 1106. The web uniformity (e.g., of the formed non-woven fabric on the collector 1110 across the width 1129 in FIG. 12A) hinges largely on the design and fabrication of the spinneret 1220. As shown in FIG. 12E, in an embodiment the die assembly 1106 includes the spinneret 1220 positioned within a die nosepiece 1230 such that slots 1235a, 1235b are formed between the spinneret 1220 and the die nosepiece 1230. In these embodiments, the spinneret 1220 in the melt blowing process uses tight tolerances, which have made their fabrication very costly. The spinneret 1220 is a wide, hollow, and tapered piece of metal having several hundred orifices or holes across the width. The polymer melt is extruded from these holes to form filament strands which are subsequently attenuated by hot air (e.g. primary air stream 1126) to form the stream of polymer fibers 1128.

In some embodiments, in the spinneret 1220 smaller orifices are usually employed compared to those generally used in either fiber spinning or spun bond processes. In one embodiment, the spinneret 1220 has about 0.4-mm diameter orifices spaced at about 1 to 4 per millimeters (e.g., about 25 to 100 per inch). In an example embodiment, there are two types of spinnerets used: a capillary type spinneret 1220 (FIG. 12C) and a drilled hole type spinneret 1220′ (FIG. 12D). For the capillary type spinneret 1220, the individual orifices are actually slots that are milled into a flat surface and then matched with identical slots milled into a mating surface. The two halves are then matched and carefully aligned to form a row of openings or holes as shown in FIG. 12C. By using the capillary type spinneret 1220, the problems associated with precise drilling of very small holes are avoided. In addition, the capillary tubes can be precisely aligned so that the holes follow a straight line accurately. The drilled-hole type spinneret 1220′ has very small holes drilled by mechanical drilling or electric discharge matching (EDM) in a single block of metal, as shown in FIG. 12D. During processing, the whole die assembly 1106 is heated section-wise using external heaters to attain desired processing temperatures. It is important to monitor the die temperatures closely in order to produce uniform webs (e.g. uniform non-woven fabric across the width 1129 of the collector 1110 in FIG. 12A). In some embodiment, the die assembly 1106 temperatures range from about 215 degrees Celsius (C) to 340 degrees C.

In an embodiment, the air manifold 1108 supplies the high velocity primary air flow 1126 through the slot 1235a on the top and the slot 1235b on the bottom sides of the spinneret 1220, as shown in FIG. 12E. In this embodiment, the high velocity primary air flow 1126 is generated using an air compressor (not shown). In an example embodiment, the compressed air flow 1126 is passed through a heat exchange unit (not shown) such as an electrical or gas heated furnace, to heat the air to desired processing temperatures. The primary air flow 1126 then exits from the top and bottom sides of the spinneret 1220 through narrow air gaps, as shown in FIG. 12E. In one example embodiment, the air temperature of the primary air flow 1126 varies within a range from about 230 degrees C. to about 360 degrees C. In another example embodiment, the velocity of the primary air flow 1126 varies from about 0.5 to about 0.8 times the speed of sound.

As soon as the molten polymer is extruded from the spinneret 1220 holes, the high velocity primary air flow 1126 (exiting from the top and bottom sides of the spinneret 1220) attenuate the polymer streams to form the stream of polymer fibers 1128 (e.g. microfibers). In an embodiment, the pathogenicidal components 112 (e.g. salt crystals) are added to the primary air flow 1126 from the pathogenicidal component source 1105 (e.g. salt hopper 1205). Thus, by adding the pathogenicidal components 112 to the primary air flow 1126, the pathogenicidal components 112 adhere to the stream of polymer fibers 1128 which are heated and malleable based on the primary air flow 1126. The inventors of the present invention recognized that this advantageously adheres the pathogenicidal components 112 (e.g. salt crystals) to the stream of polymer fibers 1128 upstream of the collector 1110. In an example embodiment, in some embodiments a vacuum device 1240a, 1240b is provided to collect pathogenicidal components 112 that were added to the primary air flow 1126 but did not adhere to the stream of polymer fibers 1128. The vacuum device 1240a, 1240b advantageously returns these pathogenicidal components 112 back to the pathogenicidal component source 1105 (e.g. salt hopper 1205a, 1205b) to enhance the cost efficiency of the system 1100, 1200. FIGS. 12F through 12J are schematic diagrams that illustrates an example of various views of a hopper 1205′ of the system of FIG. 12A or 12E, according to an embodiment.

Although FIG. 12A depicts that in one embodiment, the pathogenicidal component source 1105 is a hopper 1205, in other embodiments the pathogenicidal component source 1105 includes a reverse manifold with an inlet pipe having a first diameter that branches into a plurality of outlet pipes having a second diameter smaller than the first diameter. The inventors of the present invention recognized that such a reverse manifold could be used, where pathogenicidal components 112 are provided into the inlet pipe from the pathogenicidal component source 1105 after which the outlet pipes distribute the output of pathogenicidal components 112 along a width of the stream of polymer fibers 1128 (e.g. the outlet pipes may evenly distribute the pathogenicidal components 112 across a width of the primary air flow 1126 that is directed at the stream of polymer fibers 1128). This advantageously would more evenly distribute the pathogenicidal components 112 over the width 1129 of the collector 1110 where the non-woven fabric 1130 is formed and thus assist with an even distribution of pathogenicidal components 112 embedded across the width 1129 of the non-woven fabric 1130. In these embodiments, a quantity of the plurality of outlet pipes, a value of the first diameter and/or a value of the second diameter are selected such that the pathogenicidal components 112 output from the plurality of outlet pipes are evenly distributed across the width 1129 of the non-woven fabric 1130 formed on the collector 1110.

In one embodiment, as the primary air flow 1126 containing the stream of polymer fibers 1128 (e.g. microfibers) progresses toward the collector 1110 screen, it draws in a large amount of surrounding air (e.g., the secondary air flow 1127) that cools and solidifies the fibers in the stream 1128, as shown in FIG. 12E. In some embodiments, the pathogenicidal components 112 are added to the secondary air flow 1127 (e.g. instead of or in addition to the primary air flow 1126). In these embodiments, the pathogenicidal components 112 (e.g. salt crystals) are added to the secondary air flow 1127 from the pathogenicidal component source 1105 (e.g. salt hopper 1205).

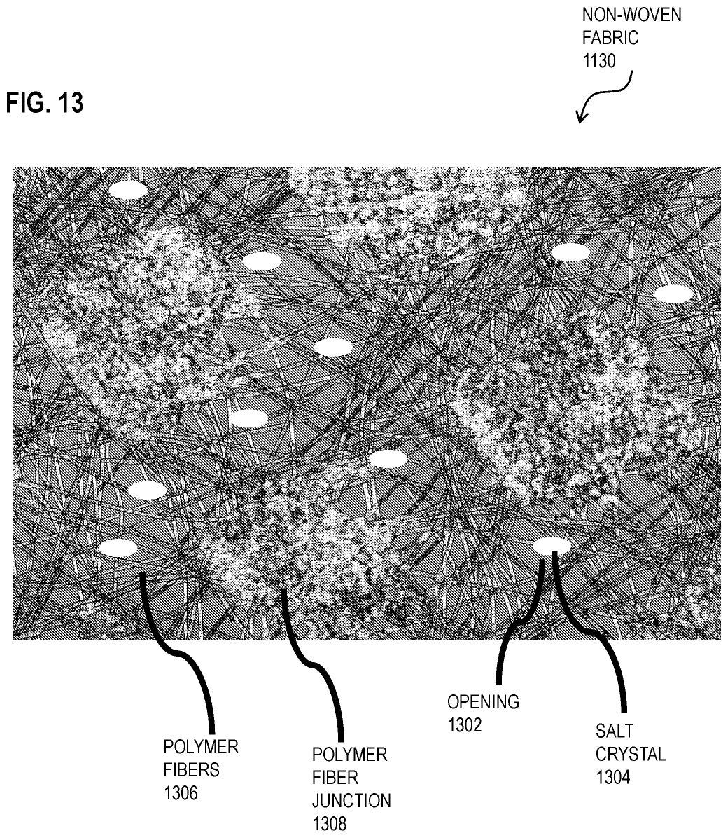

In an embodiment, after being cooled and solidified by the secondary air flow 1127, the solidified stream of fibers 1128 subsequently get laid randomly onto the collector 1110 screen, forming a self-bonded nonwoven fabric 1130. In an embodiment, the nonwoven fabric 1130 is then used to form the layer(s) 101 of the barrier 100, 100′. FIG. 13 is an image that illustrates an example of non-woven fabric 1130 with embedded pathogenicidal components 112 (e.g. salt crystals 1304) formed by the system 1100 of FIG. 11, according to an embodiment. The fibers 1306 are generally laid randomly (e.g., and also highly entangled) because of the turbulence in the air stream, but there is a small bias in the machine direction due to some directionality imparted by the moving collector 1110. As shown in FIG. 13, in some embodiments, one or more polymer fiber junctions 1308 are formed, where multiple polymer fibers 1306 adhere to one another.

As further shown in FIG. 13, in one embodiment, the non-woven fabric 1130 is porous defining multiple openings 1302 formed between adjacent polymer fibers 1306. In an embodiment, the embedded pathogenicidal components 112 (e.g. salt crystals 1304) adhere to the polymer fibers 1306 such that part of the pathogenicidal components 112 are adhered to the polymer fibers 1306 whereas another part of the pathogenicidal components 112 extend into the porous openings 1302 between adjacent polymer fibers 1306. In an example embodiment, the size of the pathogenicidal components 112 (e.g. salt crystals 1304) are chosen such that they are sufficiently large to extend into the porous openings 1302 yet at the same time sufficiently small that they do not significantly reduce the airflow through the non-woven fabric 1130 (e.g., do not completely block the openings 1302). The inventors of the present invention recognized that this arrangement advantageously enhances the likelihood of contact between the pathogenicidal components 112 (e.g. salt crystals 1304) and pathogens (e.g. virus particles) which attempt to pass through the openings 1302 of the non-woven fabric 1130. The inventors of the present invention recognized that this arrangement will likely enhance the kill efficiency of the non-woven fabric 1130 when used to form the layer(s) 101 of the barrier 100, 100′ to prevent the passage of pathogens 110 between the first and second regions 102, 104 (FIGS. 1A and 1B). The inventors of the present invention also recognized that the method disclosed herein to form the non-woven fabric 1130 is time efficient, since the non-woven fabric 1130 with embedded pathogenicidal components 112 can be formed in relatively short time (e.g., under one hour).

In an embodiment, the collector 1110 moves at a speed, in order to collect the non-woven fabric 1130. In one embodiment, the winder 1112 then collects the non-woven fabric 1130 on a reel. In an example embodiment, the collector 1110 speed and the collector 1110 distance from the spinneret 1220 can be varied to produce a variety of melt-blown webs and/or a variety of distributions of the pathogenicidal components 112 within the non-woven fabric 1130. In some embodiments, a vacuum is applied to the inside of the collector 1110 screen to withdraw the hot air and enhance the fiber laying process. In one example embodiment, the collector 1110 is a conveyor.

In an embodiment, the winder 1112 is provided to collect the non-woven fabric 1130 into a reel. In one embodiment, the melt-blown web is usually wound by the winder 1112 onto a cardboard core and processed further according to the end-use requirement. In an example embodiment, the combination of fiber entanglement and fiber-to-fiber bonding generally produce enough web cohesion so that the web can be readily used without further bonding. However, additional bonding and finishing processes may further be applied to these melt-blown webs. Additional bonding, over the fiber adhesion and fiber entanglement that occurs at lay down, is employed to alter web characteristics. In an example embodiment, thermal bonding is the most commonly used technique. The bonding can be either overall (area bonding) or spot (pattern bonding). Bonding is usually used to increase web strength and abrasion resistance. As the bonding level increases, the web becomes stiffer and less fabriclike.

In an embodiment, although most nonwovens are considered finished when they are rolled up at the end of the production line, many receive additional chemical or physical treatment such as calendering, embossing, and flame retardance. Some of these treatments can be applied during production, while others must be applied in separate finishing operations.

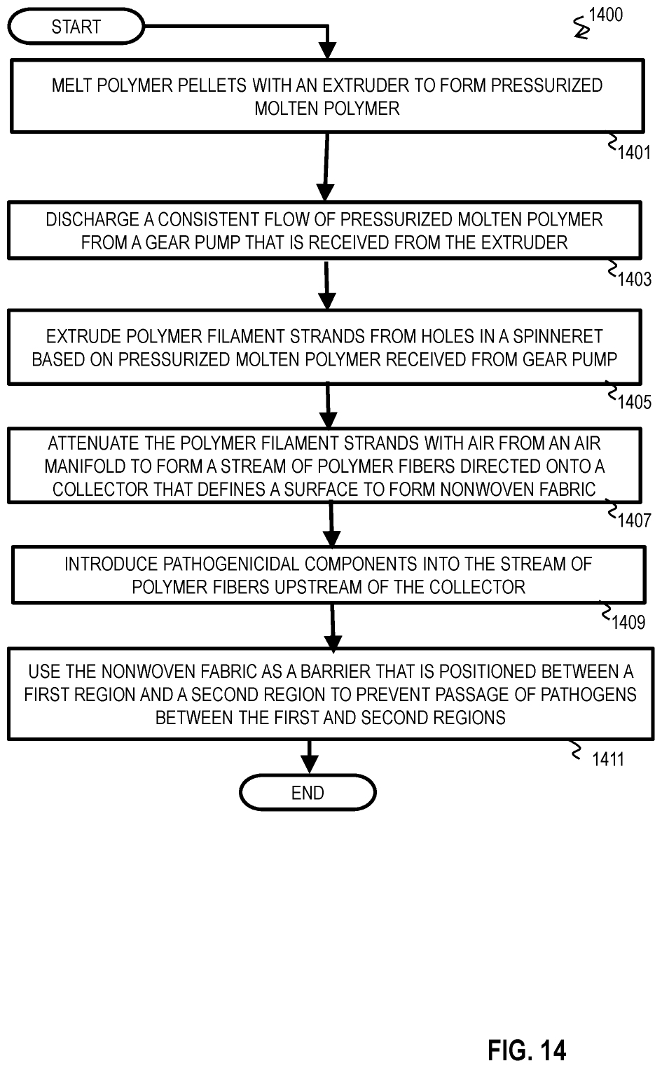

FIG. 14 is a flow chart that illustrates an example of a method 1400 for using the system of FIG. 11 to form the barrier 100, 100′ of FIG. 1A or 1B, according to an embodiment. Although steps are depicted in FIG. 14 as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

In an embodiment, in step 1401 polymer pellets are melted within an extruder to form pressurized molten polymer. In one embodiment, polymer pellets 1120 are added to the extruder 1102 (e.g. through the inlet 1201 shown in FIG. 12A). In one embodiment, the polymer pellets 1120 include one or more of polypropylene, polystyrene, polyester, polyurethane, polyamides, polyethylene, polycarbonate and polylactic acid (PLA) pellets. In an example embodiment, the polymer pellets 1120 are melted within the extruder 1102 based on the rotating screw 1202 within the heated barrel 1204. The pressurized molten polymer 1122 is then conveyed from the extruder 1102 to the gear pump 1104.

In an embodiment, in step 1403 a consistent flow of pressurized molten polymer is discharged from the gear pump. In one embodiment, in step 1403 the consistent flow of pressurized molten polymer 1124 is discharged from the gear pump 1104 based on the pressurized molten polymer 1122 received by the gear pump 1104 from the extruder 1102.

In an embodiment, in step 1405 polymer filament strands are extruded from the die assembly. In one embodiment, in step 1405 polymer filament strands are extruded from holes in the spinneret 1220 based on the consistent flow of pressurized molten polymer 1124 received from the gear pump 1104.

In an embodiment, in step 1407 the polymer filament strands extruded in step 1405 are attenuated with air from an air manifold to form a stream of polymer fibers. In one embodiment, in step 1407 the polymer filament strands extruded in step 1405 are attenuated with air from the air manifold 1108 to form the stream of polymer fibers 1128. In this embodiment, the stream of polymer fibers 1128 are directed onto the collector 1110 (e.g. across the width 1129) to form non-woven fabric 1130. In some embodiments, in step 1407 the primary air flow 1126 from the air manifold 1108 is used to attenuate the polymer filament strands to form the stream of polymer fibers 1128. In other embodiments, in step 1407 the secondary air flow 1127 from the air manifold 1108 is used to attenuate the polymer filament strands to form the stream of polymer fibers 1128. In still other embodiments, in step 1407 both the primary air flow 1126 and the secondary air flow 1127 from the air manifold 1108 is used to attenuate the polymer filament strands to form the stream of polymer fibers 1128.

In an embodiment, in step 1409 pathogenicidal components 112 are introduced into the system 1100, 1200 upstream of the collector 1110. In some embodiments, in step 1409 the pathogenicidal components 112 (e.g., salt crystals 1304) are introduced from the pathogenicidal component source 1105 (e.g. salt hopper 1205) into the primary air flow 1126 and/or the secondary air flow 1127 during step 1407 such that they adhere to the stream of polymer fibers 1128 that are malleable due to step 1407. In other embodiments, in step 1409 the pathogenicidal components 112 are introduced into the gear pump 1104 and/or into the consistent flow of pressurized molten polymer 1124 downstream of the gear pump 1104. In still other embodiments, in step 1409 the pathogenicidal components 112 are introduced into the extruder 1102 and/or into the pressurized molten polymer 112 downstream of the extruder 1102. In some embodiments, the size of the pathogenicidal components 112 (e.g. salt crystals 1304) are larger than the size of the polymer fibers within various components of the system and thus in these embodiments the pathogenicidal components 112 are not added to components of the system which may feature a filter that permits the polymer fibers to pass through but would remove the pathogenicidal components 112 from the stream of polymer fibers (e.g. extruder 1102).

In an embodiment, after steps 1407 and 1409, a winder is used to collect the formed non-woven fabric from the collector. In one embodiment, after steps 1407 and 1409, the winder 1112 is used to wrap the formed non-woven fabric 1130 from the collector 1110 into a reel. In these embodiments, the reel of non-woven fabric 1130 can then be used to form one or more items or articles with the non-woven fabric 1130.

In an embodiment, in step 1411 the non-woven fabric formed by the method 1400 is used to form the barrier 100, 100′ positioned between the first region 102 and the second region 104 to prevent passage of pathogens 110 between the first and second regions 102, 104. In one embodiment, in step 1411 the non-woven fabric 1130 (e.g. formed on the reel due to the winder 1112) is used to form the one or layer(s) 101 of the barrier 100, 100′. In an example embodiment, in step 1411 the non-woven fabric 1130 is used to form a facial cover (e.g., facial cover 200, 200′, 200″, 300, 300′). In still other embodiments, in step 1411 the non-woven fabric 1130 is used to form an air filter (e.g., air filter 404, air filter 601, etc.). In still other embodiments, in step 1411 the non-woven fabric 1130 is used to form a garment (e.g. garment 500 for a medical professional, any article of clothing or apparel, etc.). In still other embodiments, in step 1411 the non-woven fabric 1130 is used to form packaging for food items (e.g. packaging 1500 of FIG. 15A, packaging 1550 of FIG. 15B, etc.).

### 4. Performance Data for the Barrier

In one embodiment, the level of crystallization (LOC) of the salt virucidal components used in the material is measured during X-ray diffraction. X-Ray diffraction analysis is a commonly used method for microstructural analysis, specifically to determine the crystallographic structure of the material. Results of this analysis are quantified by Miller indices, a set of three compound specific numbers indicating the orientation of planes of atoms in a crystal. FIG. 8B is an image that illustrates an example of different miller indices 850 and the associated orientation of the plane of atoms in the crystal for that respective indices.

X-ray diffraction (XRD) is the experimental science determining the atomic and molecular structure of a crystal, in which the crystalline structure causes a beam of incident X-rays to diffract into many specific directions. By measuring the angles and intensities of these diffracted beams, a crystallographer can produce a three-dimensional picture of the density of electrons within the crystal. From this electron density, the mean positions of the atoms in the crystal can be determined, as well as their chemical bonds, their crystallographic disorder, and various other information.

Since many materials can form crystals—such as salts, metals, minerals, semiconductors, as well as various inorganic, organic, and biological molecules—XRD has been fundamental in the development of many scientific fields. In a single-crystal X-ray diffraction measurement, a sample (e.g. barrier 100, 100′ formed by the methods herein or a small portion thereof) is mounted on a goniometer. The goniometer is used to position the sample (e.g. barrier 100, 100′) at selected orientations. The sample (e.g., barrier 100, 100′) is illuminated with a finely focused monochromatic beam of X-rays, producing a diffraction pattern of regularly spaced spots known as reflections. The two-dimensional images taken at different orientations are converted into a three-dimensional model of the density of electrons within the sample (e.g. barrier 100, 100′) using the mathematical method of Fourier transforms, combined with chemical data known for the sample.

FIG. 8A is an image that illustrates an example of a graph 800 that depicts the XRD spectra of the barrier 100, 100′ (curve 806) relative to the XRD spectra of the conventional mask 310 (curve 808). The horizontal axis 802 is the orientation of the sample (e.g. barrier 100, 100′) relative to the beam of X-rays employed in XRD. The vertical axis 804 is intensity (arbitrary units) which indicate an electron density within the sample (e.g. barrier 100, 100′). As shown by the curve 808 of FIG. 8A, multiple peaks 806a through 806i occur in the curve 808, indicating that a crystalline structure is present at that orientation of the sample (e.g. barrier 100, 100′). Also as shown in FIG. 8A a respective miller indices are indicated at each respective peak 806a through 806i which indicate the miller index for that respective peak. In an example embodiment, the peaks 806a through 806i collectively indicate the level of crystallization of the barrier 100, 100′ for each respective plane (miler index or peak in FIG. 8A) within the barrier 100, 100′.

In an embodiment, XRD produces a diffraction pattern which provides insight on the atomic structure within the salt crystals and the intensity associated with it quantifies the electron density in the crystalline lattice planes (in arbitrary units, see vertical axis 804). The inventors of the present invention recognized that when lower concentration values of salt were used, the intensity of the XRD diffraction pattern would respectively decline, since less salt was used. In an example embodiment, the peaks 806a, through 806i are correlated to that of NaCl, since every crystal has a specific miller indices. In an example embodiment, the average intensity achieved with the salt concentration values used herein was about 3 au (arbitrary units), with crystal specific peaks having higher values.

In one embodiment, a filtration efficiency of the barrier 100, 100′ is another parameter that is measured and utilized in developing the barrier 100, 100′. The purpose of particulate filtration efficiency (PFE) is to display adequate filtration of monodispersed particles under a constant flow rate (e.g. using ASTM F2299 method). In an embodiment, to measure the PFE of the barrier 100, 100′, a predetermined amount of polystyrene latex particles (e.g., mean particle diameter of about 0.216±0.0009 μm; Agar Scientific) are passed through the material at a constant flowrate (e.g. about 10 cm/second). Light scattering is used to quantify the particle count downstream. An efficiency value is calculated using:

$$E = 100 ( 1 - \frac{{M}_{d}}{{M}_{u}} ) \qquad ( 1 )$$

Where E is the value of the PFE; Ma is the particle count downstream of the barrier 100, 100′ and Mₙ is the particle count upstream of the barrier 100, 100′. In one embodiment, M_{d} was held constant by using manufacturer particle concentration of about 1.80×10¹¹ n/mL.

Table 1 below indicates values of the PFE for a conventional fleece mask; a conventional 3 ply surgical mask and for the barrier 100, 100′ (or “amp shield” in Table 1). As indicated by the values of PFE in Table 1, the filtration efficiency of the barrier 100, 100′ is about 98.7% and higher than the filtration efficiency of both conventional masks.

TABLE 1

| Material | Mᵤ | M_{d} | E |
|---|---|---|---|
| Fleece Mask | 9 × 10⁹ | 2.722 × 10⁹ | 69.75% |
| 3 Ply Surgical Mask | 9 × 10⁹ | 2.196 × 10⁸ | 97.56% |
| Amp Shield | 9 × 10⁹ | 1.17 × 10⁸ | 98.7% |

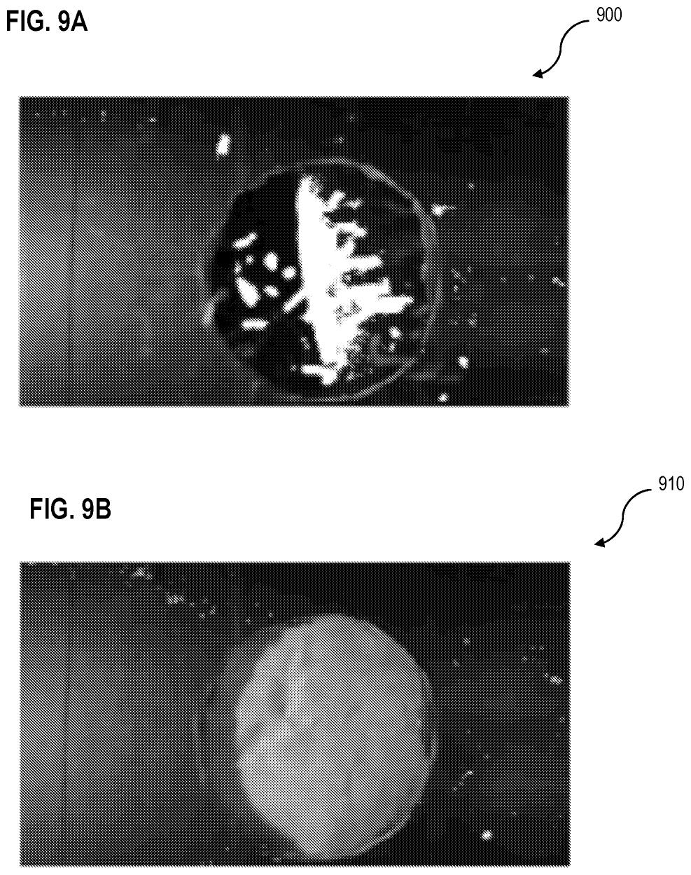

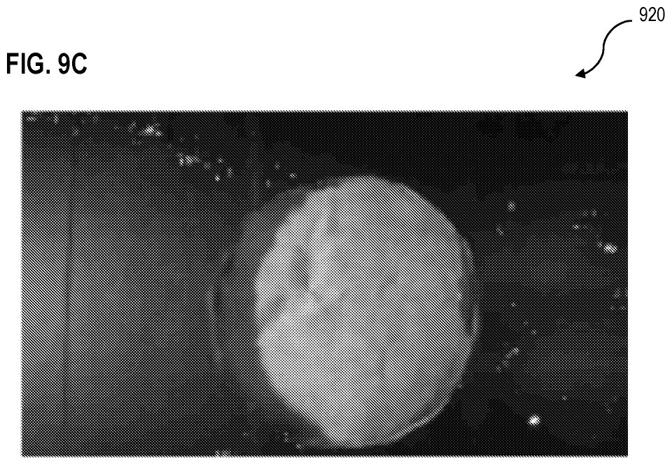

FIG. 9A is an image 900 that illustrates an example of light scattering of particles downstream of a conventional mask (e.g. Fleece mask), according to an embodiment. FIG. 9B is an image 910 that illustrates an example of light scattering of particles downstream of a conventional surgical mask (e.g. 3 ply surgical mask), according to an embodiment. FIG. 9C is an image 920 that illustrates an example of light scattering of particles downstream of the barrier 100, 100′ of the facial cover 200 (e.g. Amp shield in Table 1) of FIG. 2A, according to an embodiment.

In one embodiment, a viral/bacterial filtration efficiency (VFE/BFE) of the barrier 100, 100′ is another parameter that is measured and utilized in developing the barrier 100, 100′. The purpose of VFE/BFE is to quantity performance of the barrier 100, 100′ in filtering out bacteria and viruses (e.g. using ASTM F2101 method). In one embodiment, the ASTM F2101 method that measures BFE is based on aerosolized liquid suspension of Staphylococcus aureus (e.g. mean particle size of 3.5±0.6 μm; Sigma Aldrich) passed through target material at a constant flow rate of 1 ft3/min in a six-stage Andersen sampler. Each of the tiers contain an agar plate acting as a medium for growth of any bacteria which passes through the material.

In one embodiment, the ASTM F2101 method that measures VFE is based on bacteriophage ΦX174 that is aerosolized (e.g., mean size of virus-containing water droplet 3.2±0.4 μm, not individual viruses), which only infects E. coli, and then targeted at sample. Rather than bare agar plates, they are inoculated with Escherichia coli.

For both BFE and VFE tests, results are compared to a control test in the absence of the barrier 100, 100′. The BFE and VFE are calculated using:

$$B F E = 100 ( \frac{C - F}{C} ) \qquad ( 2 )$$

$$VFE = 100 ( \frac{C - F}{C} ) \qquad ( 3 )$$

where C and F are the control and filter results. Tables 2 and 3 below indicates the values of BFE (Table 2) and VFE (Table 3) for the barrier 100, 100′ (AMP) and the control. As indicated by the values of BFE in Table 2 and VFE in Table 3, the BFE and VFE values of the single ply layer 101 is about 99.4-99.5%.

TABLE 2

| | Initial | Final | |
|---|---|---|---|
| | Sample | Sample* | |
| Material | (CFU) | (CFU) | BFE |
| Control | 1500 | 1494 | 0.4% |
| AMP | 1500 | 9 | 99.4% |

TABLE 3

| | Initial | Final | |
|---|---|---|---|
| | Sample | Sample | |
| Material | (PFU) | (PFU) | VFE |
| Control | 1100 | 1098 | 0.18% |
| AMP | 1100 | 5 | 99.54% |

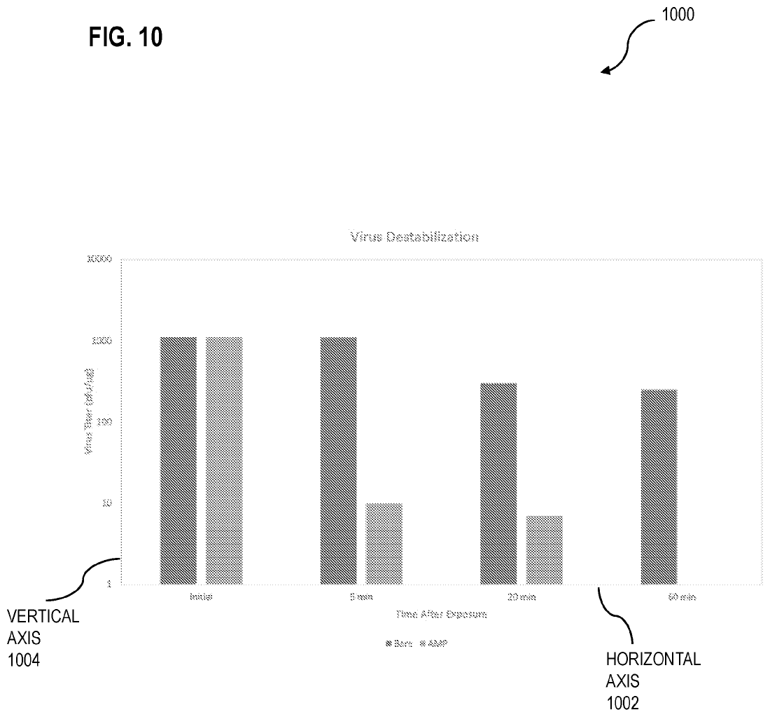

FIG. 10 is an image that illustrates an example of a graph 1000 that depicts the VFE of the barrier 100, 100′ of FIG. 1A or 1B, according to an embodiment. The horizontal axis 1002 is time of exposure in units of minutes and the vertical axis 1004 is virus tiers in units of pfu/μg). In an embodiment, the left bar at each time value indicates the virus tiers in the conventional mask 310 and the right bar at each time value indicates the virus tiers in the barrier 100, 100′. As shown in FIG. 10, both the conventional mask 310 and barrier 100, 100′ have the same virus tier value (about 1000) at the initial exposure time. As further shown in FIG. 10, after 5 minutes of exposure, the conventional mask 310 still has the same virus tier value (about 1000) at the initial exposure time whereas the barrier 100, 100′ has a much smaller value (about 10) than at the initial exposure. This confirms that after merely 5 minutes, the barrier 100, 100′ has deactivated or killed at least 95% of the virus tiers at the initial exposure time. FIG. 10 also shows that at later exposure times (e.g. 20 minutes, 60 minutes) the virus tier level on the conventional mask 310 remains relatively high (about 700) whereas the virus tier level on the barrier 100, 100′ reduces to about 0. In another embodiment, almost complete hemagglutinin (HA) activity loss was exhibited. Specifically, glycoprotein was found on the surface of viruses, integral to their infectivity. Through microscopic analysis, it was confirmed that the aerosol drying time was nearly 3 minutes. This indicates that destruction of virus is correlated with the drying induced salt crystallization.

In one embodiment, a fluid resistance of the barrier 100, 100′ is another parameter that is measured and utilized in developing the barrier 100, 100′. The purpose of fluid resistance is to provide adequate resistance to the transfer of fluids from its out to its inner layers due to splashing or spraying. In an example embodiment, a particular method is employed to measure the fluid resistance (e.g. ASTM F1862). In an example embodiment, 2 mL of synthetic blood is targeted at the barrier 100, 100′ at varying velocities corresponding to the following blood pressures: 80 mmHg: Level 1, venous blood pressure; 120 mmHg: Level 2, arterial pressure; and 160 mmHg: Level 3, high pressures occurring during trauma. In one embodiment, the barrier 100, 100′ is an accessory to current masks, extending the lifetime of current masks while additionally reducing the number of possible fomites and as a result, reduction in cross contamination. Depending on the setting, the barrier 100, 100′ adapts, at all three levels improving barrier efficiency by adding an additional layer. ASTM defines passing as having at least 29 of 32 masks not showing fluid onto opposite side. Table 4 below indicates the amount of barrier 100, 100′ that passed and failed, at each level.

TABLE 4

| | | |
|---|---|---|
| Pressure | Pass | Fail |

| | | | |
|---|---|---|---|
| 80 | mmHg | 32 | 0 |
| 120 | mmHg | 32 | 0 |
| 160 | mmHg | 31 | 1 |

In one embodiment, air exchange (or air permeability) of the barrier 100, 100′ is another parameter that is measured and utilized in developing the barrier 100, 100′. The air exchange parameter, commonly referred to as AP, indicates sufficient breathability for the user wearing the facial cover (made from the single ply layer 101). That is, the ability of the barrier 100, 100′ to restrict airflow through it (e.g. using method EN 14683). In an embodiment the method for measuring air exchange (or air permeability) is employed in step 705 of the method 700 and measures the air pressure difference on both sides of the barrier 100, 100′ using a manometer, with airflow supplied at a constant flowrate. Table 5 below indicates the values of the air exchange (or air permeability) for the requirement of FDA approval (top row of Table 5), the conventional mask 310 (second row of Table 5) and the facial cover 300 including the conventional mask 310 and the barrier 100, 100′ (third row of Table 5). Thus, in one embodiment, the air exchange (or air permeability) is based on the difference between the third row and second row of Table 5 (e.g. in a range from about 0.05 to about 0.07 mmH₂0/cm²).

TABLE 5

| | Level 1 | | Level 2 | | Level 3 | |
|---|---|---|---|---|---|---|
| Required | <4.0 | mmH₂0/cm² | <5.0 | mmH₂0/cm² | <5.0 | mmH₂0/cm² |
| Bare Mask | 3.8 | mmH₂0/cm² | 4.5 | mmH₂0/cm² | 4.7 | mmH₂0/cm² |
| Mask w/Shield | 3.87 | mmH₂0/cm² | 4.56 | mmH₂0/cm² | 4.79 | mmH₂0/cm² |

Table 6 below also indicates a summary of the measured performance parameters of the barrier 100, 100′ (far right column of Table 6) for various levels.

TABLE 6

| | Level 1 | Level 2 | Level 3 | [symbol] |
|---|---|---|---|---|
| Characteristic | | | | |
| Fluid Resistance | 80 | 120 | 160 | [symbol] |
| (mmHg) | | | | |
| BFE Percent | 95% | 98% | 98% | [symbol] |
| PFE Percent | 95% | 98% | 98% | [symbol] |
| VFE Percent | — | — | — | [symbol] |
| Differential Pressure | | | | |
| (ΔP breathability) | <4.0 | <5.0 | <5.0 | [symbol] |
| (mmH₂0/cm²) | | | | |
| Flammability | Class 1 | Class 1 | Class 1 | [symbol] |
| (flame spread) | | | | |

[symbol]

indicates data missing or illegible when filed

What is claimed is:

1. A method for forming a barrier configured to be placed between a first region and a second region, to prevent passage of pathogens between the first and second regions, the method comprising:
melt blowing a stream of polymer fibers onto a surface to form a non-woven fabric used to make the barrier;
wherein the melt blowing includes introducing pathogenicidal components into the stream of polymer fibers.

2. The method of claim 1, wherein the polymer fibers comprise one of polypropylene, polystyrene, polyester, polyurethane, polyamides, polyethylene, polycarbonate and polylactic acid (PLA).

3. The method of claim 1, wherein the pathogenicidal components comprise one or more of salt, acid and esters.

4. The method of claim 1, wherein the method further comprises determining a value of one or more parameters of the introducing step including at least one of:
a location of the introducing step;
a particle size of the pathogenicidal components; and
an introduction speed of the introducing the pathogenicidal components into the stream of polymer fibers.

5. The method of claim 4, wherein the determining step is based on performing the introducing step when the polymer fibers are malleable such that the pathogenicidal components adhere to the stream of polymer fibers.

6. The method of claim 4, wherein the determining the location includes assessing that the pathogenicidal components with the particle size will not be filtered or removed from the stream of polymer fibers downstream of the location.

7. The method of claim 1, wherein the melt blowing comprises
melting, with an extruder, polymer pellets to form pressurized molten polymer;
discharging, with a metering pump, a consistent flow of pressurized molten polymer received from the extruder;
extruding, from holes in a spinneret, polymer filament strands based on the pressurized molten polymer received from the metering pump;
attenuating, with air from an air manifold, the polymer filament strands into the stream of polymer fibers that are directed onto a collector that defines the surface to form the non-woven fabric;
wherein the introducing step is performed downstream of the extruder and upstream of the collector.

8. The method of claim 7, wherein the introducing step is performed such that pathogenicidal components are introduced into the air manifold used to attenuate the polymer filament strands into the stream of polymer fibers.

9. The method of claim 8, wherein the attenuating step includes directing air from a primary air manifold into a gap between the spinneret and a die nosepiece to attenuate the polymer filament strands being extruded from the holes in the spinneret;
and wherein the pathogenicidal components are introduced into the air from the primary air manifold.

10. The method of claim 8, wherein the attenuating step includes directing air from a secondary air manifold downstream of the spinneret to attenuate the polymer filament strands being extruded from the holes in the spinneret;
and wherein the pathogenicidal components are introduced into the air from the secondary air manifold.

11. The method of claim 8, wherein the introducing step is performed with a device configured to evenly distribute the pathogenicidal components across a width of the non-woven fabric formed on the collector.

12. The method of claim 11, wherein device comprises a reverse manifold with an inlet pipe having a first diameter that branches into a plurality of outlet pipes having a second diameter smaller than the first diameter;
and wherein a quantity of the plurality of outlet pipes, a value of the first diameter and a value of the second diameter are selected such that the pathogenicidal components output from the plurality of outlet pipes are evenly distributed across the width of the non-woven fabric formed on the collector.

13. The method of claim 11, wherein the device comprises a hopper configured to gravity feed the pathogenicidal components into the air manifold.

14. The method of claim 13, further comprising a vacuum to direct pathogenicidal components that do not adhere to the stream of polymer fibers back to the hopper.

15. The method of claim 1, wherein the non-woven fabric comprises non-woven polymer fibers with porous openings, wherein a first portion of the pathogenicidal components adhere to the non-woven polymer fibers and a second portion of the pathogenicidal components extend into the porous openings between adjacent polymer fibers in the non-woven fabric.

16. The method of claim 15, wherein the pathogenicidal components include salt such that the first portion of salt crystals adhere to the non-woven polymer fibers and the second portion of salt crystals extend into the porous openings between adjacent polymer fibers in the non-woven fabric.

17. The method of claim 1, wherein the non-woven fabric used to make the barrier has a virus kill rate of at least 95%.

18. A device of a system to form a barrier configured to be placed between a first region and a second region, to prevent passage of pathogens between the first region and the second region, the system comprising an extruder configured to melt polymer pellets to form pressurized molten polymer, the system further comprising a metering pump configured to discharge a consistent flow of pressurized molten polymer received from the extruder, the system further comprising a spinneret configured to extrude polymer filament strands from holes defined by the spinneret based on the pressurized molten polymer received from the metering pump, the system further comprising an air manifold configured to attenuate the polymer filament strands into the stream of polymer fibers that are directed onto a collector that defines the surface to form the non-woven fabric, wherein:
the device is configured to introduce pathogenicidal components into the stream of polymer fibers downstream of the extruder and upstream of the collector.

19. A barrier formed by the method of claim 1, comprising a first side directed toward the first region and a second side directed toward the second region.

20. The barrier of claim 19, wherein the pathogenicidal components are virucidal components comprising salt with a level of crystallization of across a thickness of the barrier from the outer surface of the first side to the outer surface of the second side.

21. The barrier of claim 19, wherein the barrier is a single ply layer.

22. The barrier of claim 19, wherein the barrier comprises multiple layers and wherein each layer is formed by the method of claim 1.

23. The barrier of claim 19, wherein the barrier has a viral filtration efficiency of at least 95% between the first region and the second region.

24. The barrier of claim 19, wherein the barrier is configured to be worn on a face of a user, such that the first region is an external surrounding of the user and the second region is the face of the user.

25. The barrier of claim 24, further comprising an adhesive on the outer surface of the second side such that the second side is configured to be directly attached to the face of the user with the adhesive.

26. A facial cover to be worn by a user, comprising:
the barrier formed by claim 1, wherein the barrier includes one or more layers;
wherein the one or more layers are configured to deactivate pathogens incident from the external surrounding of the user.

27. The facial cover of claim 26, further comprising multiple layers, each layer formed by the method of claim 1.

28. The barrier of claim 19, wherein the barrier is an air filter configured to be placed in a conduit of an air conditioning system, wherein the first region is the conduit configured to direct a flow of air and wherein the second region is an area to receive the flow of air after passing through the air filter.

29. The barrier of claim 19, wherein the barrier is an air filter configured to be placed in a conduit of a respirator used with a patient, wherein the first region is the conduit configured to direct a flow of air exhaled by the patient and wherein the second region is external surroundings of the respirator in a medical facility.

30. The barrier of claim 19, wherein the barrier is a garment configured to be worn by a medical professional, wherein the first region is external surroundings of the medical professional in a medical facility and the second region is the body of the medical professional.

31. The barrier of claim 19, wherein the barrier is food packaging that is configured to enclose one or more food items, wherein the first region is external surroundings of the one or more food items and the second region includes the one or more food items.

32. The barrier of claim 31, wherein the food packaging is configured to enclose individual food items such that the barrier is used to individually wrap the one or more food items.

33. The barrier of claim 31, wherein the food packaging is configured to enclose a container of the one or more food items such that the first region is external surroundings of the container and the second region is an interior of the container including the one or more food items.
